(19) United States
(12) Patent Application Publication
(10) Pub. No.: US 2026/0238612 A1
(43) Pub. Date: Aug. 13, 2026

(54) COMPUTER-IMPLEMENTED METHODS AND SYSTEMS

(71) Applicant: nChain Licensing AG, Zug (CH)

(72) Inventors: Alessio PAGANI, London (GB); Jack Owen DAVIES, London (GB); Mathieu DUCROUX, London (GB); Craig Steven WRIGHT, London (GB); Luigi LUNARDON, London (GB)

(21) Appl. No.: 19/155,199

(22) PCT Filed: Feb. 15, 2024
(86) PCT No.: PCT/EP2024/053840

§ 371 Date: Aug. 8, 2025

(30) Foreign Application Priority Data
Feb. 20, 2023 (GB) 2302367.4
Jul. 28, 2023 (GB) 2311631.2
Jul. 28, 2023 (GB) 2311632.0
Jul. 31, 2023 (GB) 2311767.4
Sep. 4, 2023 (GB) 2313473.7
Dec. 29, 2023 (GB) 2320118.9

(51) Int. Cl. H04L 61/5069; H04L 9/40; H04L 61/5007; H04L 101/695

(52) U.S. Cl. CPC H04L 61/5069; H04L 61/5007; H04L 63/0485; H04L 2101/695

(57) ABSTRACT

The invention resides in a computer-implemented communication method. The method comprises a mechanism for service provisioning from a service provider to one or more devices in a plurality of devices controlled by, or associated with, a device controller. In an example embodiment, the service provider allocates a set of IPv6 addresses to the device controller. In turn, the device controller allocates or communicates one or more of the set of IPv6 addresses to at least one of the devices. The device then includes the one or more IPv6 address that it has received from the device controller in an access request to the service provider. Upon verification that the requesting device is authorised by the device controller, the service provider provides the service to the one or more addresses included in the access request.

### CROSS REFERENCE TO RELATED APPLICATIONS

This application is the U.S. National Stage of International Application No. PCT/EP2024/053840 filed on Feb. 15, 2024, which claims the benefit of United Kingdom Patent Application No. 2302367.4 filed on Feb. 20, 2023, United Kingdom Patent Application No. 2311631.2 filed on Jul. 28, 2023, United Kingdom Patent Application No. 2311632.0 filed on Jul. 28, 2023, United Kingdom Patent Application No. 2311767.4 filed on Jul. 31, 2023, United Kingdom Patent Application No. 2313473.7 filed on Sep. 4, 2023, and United Kingdom Patent Application No. 2320118.9 filed on Dec. 29, 2023, the contents of which are all incorporated herein by reference in their entireties.

### TECHNICAL FIELD

Embodiments disclosed herein relate to improvements for transmission of data e.g. packets of data across a computer-implemented network. Embodiments are particularly suited for, but not limited to, transmission of data relating to service provisioning between a service provider and at least one service recipient. The service provider may also be known herein as a ‘data provider’. The service (i.e. data) recipient may be a controller of multiple devices that each need to receive and/or send data between the individual devices and the service provider. Embodiments provide enhanced control, transmission and/or monitoring of such data-related services across an electronic network between the service provider and controller's multiple devices. Embodiments also provide improved verification and permissioning techniques for multiple devices owned or controlled by a common controller. Preferred embodiments provide solutions which comprise the combination of Public Key Infrastructure (PKI) with mobile IP (MIP), and some embodiments may utilise a blockchain for performance of access control, device verification and authorisation processes.

### BACKGROUND

Devices on the Internet are assigned a unique identifier (address) that allows them to be identified and located on the network by other devices. The initial IP protocol was built with the expectation that the number of IP addresses that could be generated from the 32 bit length address block would be sufficient to uniquely identify all of the devices that would connect to the Internet. However, neither the enormous private and commercial appeal of the Internet, nor the variety and quantity of devices that would seek to connect to it, was conceivable when the initial IP protocol was designed.

As a result, it became evident over time with the growth in personal computing and mobile computation technology that the 4.3 billion addresses that are possible with IPv4 was insufficient.

While the threat of exhaustion of IPv4 addresses led to some creative ways of mitigating the limited set (e.g., Classless Inter-Domain Routing (CIDR), Unnumbered interface, and network address translation), these measures were not sufficient to address the issue. The advent of Internet of Things (IoT) exacerbated the limitations of IPv4 even further in the near and long term.

Due to these challenges, IPv6 was proposed as a replacement for the IPv4 address standard. Central to IPv6 was its use of a 128 bit address which can theoretically produce 3.4×10³⁸ addresses. While several ranges of the key space are pre-designated for specific purposes, the remaining address space is large enough to meet current and future needs of each resource that connects to the Internet having its own unique IPv6 address. Although the most significant advantage of IPv6 is that of a larger address space, there are several other advantages that IPv6 is expected to provide. These include the IPv6 approach toward multicasting and anycasting, and also implementations such as Mobile IPv6, Proxy Mobile IPv6 (PMIPv6).

Multicasting, which enables the transmission of a data packet to multiple destinations in a single send operation, is native to the base specification of IPv6. For IPv6, packets are sent to a multicast group address; the packets are then sent on to the members of the group. On the other hand, an IPv6 anycast transmission enables a source resource to send a data packet to a group address but only one recipient of the group (the topologically closest to the sender) receives the transmitted data.

The group subscription model of multicasting and its incorporation in IPv6 protocol leads to greater efficiencies in transmission of data packets across the Internet and less network congestion in comparison with other ways of transmitting/casting packets such as unicasting and broadcasting. Unicasting is a one-to-one connection where a packet is sent from one IP address to another. Broadcasting is a one-to-all transmission where a packet is sent to all addresses/nodes in the network. Thus, the use of multicasting in IPv6 provides a more efficient and scalable solution for transmitting data over the Internet.

In situations where a controller has multiple devices that need to receive services from a service provider, challenges arise including, but not limited to, how the device controller manages the PKI aspects across the devices, and how the service provider is able to verify that a request from a particular device is authorised by the controller without repeatedly reverting to the controller to confirm the device's authorisation. In the latter scenario, such repeated authorisation for individual devices by the controller is not only inefficient in terms of time and processing, but it gives rise to potential exploits by third parties that can intercept the communications and causes undue processing burden on the controller. It also reduces the system's ability to scale, and reduces the resilience by centralising the permissioning responsibility at the controller. These challenges are exacerbated in dynamic and frequently changing environments where many devices may be joining or leaving the controller's group.

Therefore, there is a need for solutions that address at least these challenges.

### SUMMARY

Embodiments of the disclosure provide solutions for the transmission of data across a computer-based network. In particular, embodiments comprise the integration and use of PKI, cryptographic keys, and IP address blocks for entities (e.g. users) that are associated with multiple devices. Ideally, but not necessarily, embodiments may also incorporate the use of mobile IP (MIP) and/or blockchain technologies.

Embodiments of the disclosure comprise the use of cryptographic keys for accessing services, by a first entity/user, that are provided by a second entity/user. Preferably, the key holder (or one or more entities/users that are authorised by and/or on behalf of the key holder) is the only party that is able to access the service. Preferably, ownership of the key remains secret, thereby preserving the user's privacy.

The service provider may provide any type of digital service across an electronic network or communications channel for consumption by electronic device(s) associated with a first user. This may comprise the provisioning of data for any purpose, in any format, for any end use. Thus, the service may be called a ‘data service’. In some examples, the service may be cloud-based. The data may comprise provision of multiple packets across the network. The electronic devices are not limited to any particular form of hardware, software or purpose, but may comprise mobile phones, laptops, drones, vehicles and transportation apparatus, desktop computers, IoT devices, wearable devices and more.

Herein, we may refer to the first entity/user as a “device controller” to distinguish this entity from end users of the individual devices that belong to i.e. are under the control or authority of the first user. The term “device” is used herein in a broad sense for the sake of convenience, and should be interpreted as including single, standalone devices and also collections of associated devices or systems.

In an example embodiment, a device controller is associated at a service provider with at least one of allocated IP addresses and at least one master cryptographic key or key pair. Each master key may be associated with one or more sets or sub sets of allocated IP addresses and vice versa.

Hereafter, when we refer to a set of addresses we mean at least one address, and the set may be at subset of a larger set of addresses, or comprise at least one sub set of addresses. In embodiments where multiple address sets are associated with (i.e. allocated to) the same device controller, a different master key may be linked to each address set, but this is not necessarily the case for all embodiments. In some embodiments, the IP block may be an IPv6 block which may be assigned to a device controller that comprises or is associated with multiple computing resources (devices). One or more addresses in the set may be IPv6 multicast or anycast addresses.

Non-limiting examples of a device controller could include a department, group or section within a company, organisation or other entity e.g. a household, or authorised parties who are signatories or participants to an agreement such as a contract e.g. personnel carrying out a specified role or employment, members of a military regiment or group, a vehicle dealership or operator that owns a fleet of autonomous vehicles etc. For example, where a device controller is a member of a household e.g. a parent, the associated devices may comprise laptops, mobile phones, electric vehicles etc that are owned or operated by different family members in that household. In another non-limiting example, the device controller may be in control of a group of workers or operatives (e.g. paramedics, soldiers, sales personnel, autonomous vehicles etc), each associated with a transmitting device so that the location of the devices and any other relevant data can be monitored at a base such as a home, a headquarters, office, car showroom etc.

In turn, the device controller may allocate one or more addresses from respective one or more of its allocated address sets (or subsets) to at least one specified device within its group of associated (controlled) devices. The device controller may allocate at least one subkey to at least one of the specified devices. The subkey(s) may be derived from a master key associated with e.g. generated or controlled by) the device controller. The subkey may be generated in a deterministic way, such that it is provably derived from the master key (or another subkey derived from the master key).

When the device wishes to access the services of the service provider, the device may provide a cryptographically signed access request to the service provider. The request may comprise an identifier that enables the service provider to identify the service provider. For example, the request may include an account number or cryptographic key that the service provider recognises as associated with the device controller.

In some embodiments, the request may be signed by the requesting device using the device controller's master key or its own deterministic subkey. This may enable the service provider to identify the device controller from the request and/or facilitate verification of the device controller's authorisation of the request.

Additionally, or alternatively, the access request may comprise the key such that the service provider can extract a copy of the key from the request. The access request may also comprise an indication of its allocated IP address(es). Upon receipt of the request, the service provider can check which IP block the device's IP address belongs to and determine the master key that is associated with that IP block. If the device has provided a subkey instead of the master key, the service provider may verify that the subkey was derived from the master key that it has stored on record in a storage facility in association with the device controller.

If the (sub)key that the device provides in the request does not match, or cannot be verified as deriving from, the master key for the device controller that is associated at the provider with the device controller and/or the IP address(es) indicated in the request, the service provider may reject the request and deny access to its data-related services. Alternatively, if the verification succeeds, the service provider may grant access to the data services. This may comprise transmission of data from the service provider or another entity on its behalf to the IP address(es) indicated in the request. Where the indicated IP address is a multicast address, this may enable distribution of the provider's services to a plurality of members of that multicast address.

Thus, embodiments may provide at least the benefits of efficient, secure and pseudonymous provisioning of data and services to multiple recipients. One, some or all of the recipients may be multicast groups, or anycast groups, further enhancing the distribution of services and data to multiple receivers.

Advantages include, but are not limited to the following aspects:
Authorised receiving devices can be added or removed dynamically by the device controller, without processing or cost implications for the service provider. This is beneficial in situations where a controlling entity may wish to provide specified data services to authorised devices on a temporary basis e.g. guests in a hotel for a duration of their stay, employees using a company's mobile phone during working hours etc.
Allocated addresses could be multicast, unicast or anycast addresses; this means that data can be provided from the service provider to one or many recipients in an efficient and swift way.
As embodiments enable data provisioning to devices based on subkeys generated from an authorised device controller's master key, the access can be pseudonymous. This may be helpful, for example, in situations where a device controller is not authorised or willing to share information relating to an end-user of a device, but can provably trace the device that requested the access by means of a deterministic and provable subkey.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain.

FIG. 2 schematically illustrates some examples of transactions which may be recorded in a blockchain.

FIG. 3A is a schematic block diagram of a blockchain-based client application.

FIG. 3B is a schematic mock-up of an example user interface that may be presented by the client application of FIG. 3A.

FIG. 4 is a schematic block diagram of some node software for processing blockchain transactions.

FIG. 5 shows an embodiment of the invention, in which resources belonging to multicast groups communicate with one another for the secure, efficient and speedy distribution of electronic data.

FIG. 6a shows example of an IPv4 address in dot-decimal notation.

FIG. 6b shows an example of an IPv6 address in hexadecimal notation.

FIG. 6c shows how an address prefixes can be reserved for representing IPv6 address types.

FIG. 7 shows a unicast transmission of a data packet from a server's address to the global unicast address of a computer (shown as PC1).

FIG. 8 shows a multicast transmission, for comparison with the unicast transmission of FIG. 7; here, the data packet sent from the server is routed through the internet to the multicast address for retrieval by subscribers.

FIG. 9 shows an anycast transmission, for comparison with FIGS. 7 and 8, in which the server sends a data packet to an anycast address; the data packet is forwarded to the topologically nearest router/node of a subscribed set of resources.

FIG. 10 shows propagation of data across a network, for example a blockchain network or other network.

FIG. 11 shows an example embodiment of the disclosure, in which a node in a network performs a multicast transmission of one or more portions of data.

FIG. 12 shows an example embodiment of the disclosure, in which a node in a network performs an anycast transmission to an anycast address.

FIG. 13 shows a node B on a network broadcasting via multicast transmission to a plurality of nodes N1 to N4 in the network.

FIG. 14 shows a node B on a network broadcasting via multicast transmission to allocated addresses via each of its eight outputs to nodes N1 to N8 in the network.

FIG. 15 shows a node B on a network, receiving data from node A, and broadcasting via multicast transmission to allocated addresses represented by a plurality of nodes N1 to N4 in the network.

FIG. 16 shows a node B on a network, which has subscribed to receive multicast broadcasts from nodes C, D and E, and broadcasting to allocated addresses via multicast transmission to each of its eight outputs to nodes N1 to N8 in the network.

FIG. 17 shows a node B transmitting a packet of data to a multicast group, a first subscriber and a second subscriber, wherein the second subscriber optionally further transmits the packet of data to the first user either directly or via a second multicast group.

FIG. 18 shows a node B transmitting eight packets of data to eight respective multicast groups, a first subscriber subscribing and accessing packets of data from two of the eight multicast groups, and a second subscriber that, optionally, aggregates said eight packets of data and transmits them to a ninth multicast group thus providing the first subscribe to alternative access to said eight packets of data.

FIG. 19 shows a node B transmitting eight packets of data to eight respective multicast groups, and six subscribers, such as drones, accessing one or more packets of data.

FIG. 20 provides a flowchart that illustrates steps potentially taken by participants in a method according to some embodiments of the present disclosure.

FIG. 21 shows an illustration some of the possible components of a system arranged in accordance with an embodiment of the disclosure.

### DETAILED DESCRIPTION OF ILLUSTRATIVE EMBODIMENTS OF THE DISCLOSURE

With reference to the accompanying figures, we now provide illustrative embodiments that can be used to provide the technical effects and benefits of the disclosure.

In an example embodiment, computer-based resources may be associated to form one or more multicast groups, each group having its own, respective multicast address. A multicast group address is a logical, collective identifier for the resources in the group so that they can all receive data packets from sending nodes via multicast communications. In some embodiments, the address is an IPv6 multicast address, and the data is sent and received over the internet.

FIG. 5 illustrates each of the three multicast groups of resources communicating with one another. A communication may comprise sending one or more packets of data in a transmission. The data may be blockchain-related data but not necessarily so. In some embodiments, the data may be any type of data that is provided from a service provider to a device that is controlled (and/or owned) by a device controller. There may be many devices that are controlled by the device controller. These devices may take any form, or service any purpose. Herein, the term “device” may be used interchangeably with “computing resource” or “system”, so as to include a plurality of individual devices. Each device may be operated by one or more human operatives, or may be automated such that the behaviour and/or functionality of the device(s) is influenced or dictated by a portion of machine-executable code.

When using multicast, a resource of a multicast group, for example group 502a, may send data to the same group 502a, and/or another multicast group e.g. 502b, in the form of a single transmission to a single multicast address corresponding to or associated with multicast group 502a/502b. In this way, only one transmission is sent and only (but all) resources that are members of the receiving multicast group receive the data.

When using anycast, a resource 501 of a multicast group, for example group 502a, may transmit data by sending it to the same group 502a or another multicast group e.g. 502b in the form of a single transmission to a single anycast address corresponding to or associated with multicast group 502b. The data packet(s) are routed to a resource 501 of multicast group 502b that is determined to be the topologically closest to the sending resource. The receiving resource may then forward the data to one or more of the other resources of multicast group “b” or to any other resource(s) in one or more of the other groups, or even to any other resource that is not part of any group. In this way, only one data transmission is sent to a single recipient within a particular group but then that data can be disseminated across other members of the group via a multicast transmission. This is advantageous in situations where only one or a subset of the multicast group needs to receive the transmission in order to provide the data to the entire group. Similarly, a resource of a multicast group may send or receive data using multicast or anycast.

When using multicast, a resource of a multicast group, for example group “b”, may send data, such as requested data in response to such a request, by sending the data to multicast group “a” in the form of a singular data transmission to a single multicast address corresponding to multicast group “a”. In this way, only one data transmission instance is required and only the member resources of multicast group “a” receive the data. In this embodiment, the sending resource may be referred to as a “sending resource” and the member resources of multicast group “a” as “receiving resources”.

When using anycast, a resource of a multicast group, for example group “b”, may send data, such as requested data in response to a received request, by sending the data to multicast group “a” in the form of a singular data transmission to a single anycast address corresponding to multicast group “a”. The data is routed to a resource of multicast group “a” determined to be topologically closest to the resource that sent the data. The receiving resource may then forward the data to the other resources of multicast group “a”. In this way, only one data transmission instance is required to have the data arrive at multicast group “a”, only the member resources of multicast group “a” receive the data, and the possibility that only a subset of the multicast group needs the data is addressed.

As known in the prior art, Internet Protocol (IP) is the communications protocol that provides an identification and location system for computers on networks and routes data packets across the Internet. Resources (i.e. devices/systems) on the Internet are assigned a unique IP address for identification and location definition. IPv6 was designed with a view to providing a solution to the IP address deficiencies arising from IPv4.

### IPv6 Addresses:

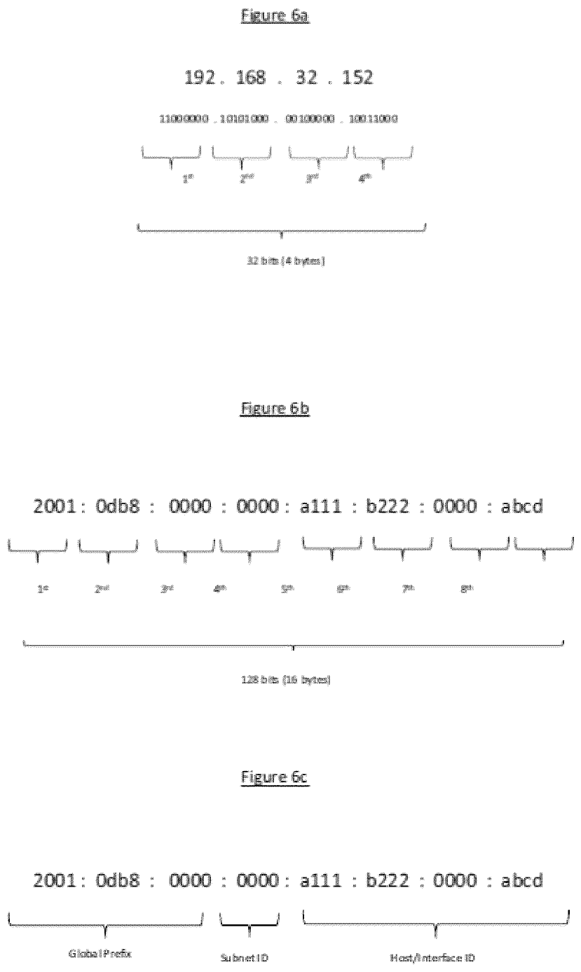

An example of an IPv4 address in dot-decimal notation is shown in FIG. 6a. It is composed of four 8-bit sections, each separated by dots and referred to as an octet. For the purpose of comparison, an example of an IPv6 address is shown in FIG. 6b in hexadecimal notation, wherein each hexadecimal character represents a series of 4 bits. The address is composed of eight 16-bit sections, each separated by colons. Each 16-bit section is referred to as a hextet. This address can be simplified using a variety of rules, including i) replacing multiple consecutive all-zero hextets with a double colon (only once), and ii) removing any leading zeros for hextets; this produces:
2001:db8::a111:b222:0:abcd

Given the difference in the address formats, IPv6 allows for a greater quantity of addresses compared to IPv4. In turn, this provides the ability to reserve address subspaces for different address types. Address prefixes are reserved for representing various address types as illustrated in FIG. 6c, in which the global prefix is the block of IP addresses provided to an end user by their Internet Services Provider (ISP). At minimum, it is 88 bits long, with the Subnet ID comprising 16 bits and the host/Interface ID comprising 64-bits. These address types typically represent different methods of casting information within the network, including those shown in the Table below:

TABLE 1

| Type of address | Prefix | Info |
|---|---|---|
| Global Unicast | 2000::/3 | Publicly routable |
| Unique Local | FC00::/7 | Routable in LAN |
| Link local | FE80/10 | Not routable |
| Multicast | FF00::/8 | Addresses for groups |
| Anycast | 2000::/3 | Shared address |

### Multicast:

Multicast is a one-to-many network transmission solution where a sending resource transmits a single data packet to multiple destinations. The resource only sends one copy of the data through the network. Resources that have subscribed to the data feed that the sender transmits on would then receive a copy of the data after it is replicated at the applicable junction in the network. Multicast transmissions are especially efficient with respect to bandwidth consumption as the sending resource only sends one copy of the data even though all group subscribers receive a copy. This is in contrast to unicasting where the sending resource establishes a connection with each intended recipient and sends each a separate copy of the data.

As shown in FIG. 6c, subspaces of IPv6 addresses can be designated for use with different types of addresses (unicast, multicast, etc). The address shown in FIG. 6c (2001:0db8::a111:b222:0:abcd) is an example of such an address. For a unicast transmission, the data packets are sent from one global unicast address to another. There are different types of IPv6 unicast addresses. A global unicast address is a routable unicast address. (This is similar in usage to that of a public IPv4 address)—see, for example, www.ciscopress.com/articles/article.asp?p=2803866&seqNum=4.

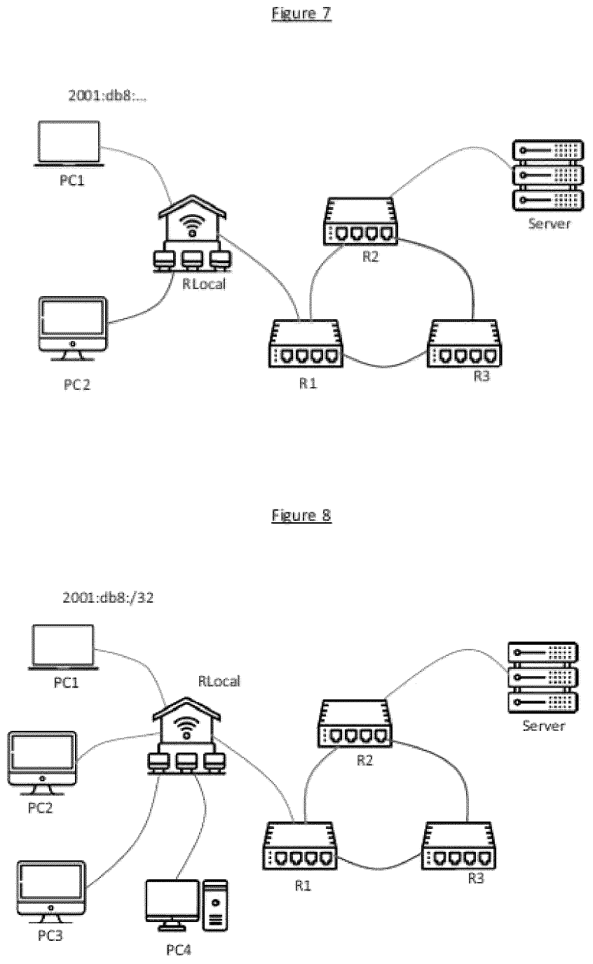

With reference to FIG. 7, a unicast transmission of a data packet from the server's address to the global unicast address of PC1 would result in the data packet being routed through the internet and arriving at PC1 with address 2001:db8::a111:b222:0:abcd. PC1 would be the only resource that processes the data packet.

For multicast, instead of sending the data packet to an address of PC1, the data packet is sent to a multicast address. This would be to an IPv6 address with the prefix FF. Resources that would like to receive the data from the sender join the multicast group that is associated with that multicast address. This is called their “subscription”.

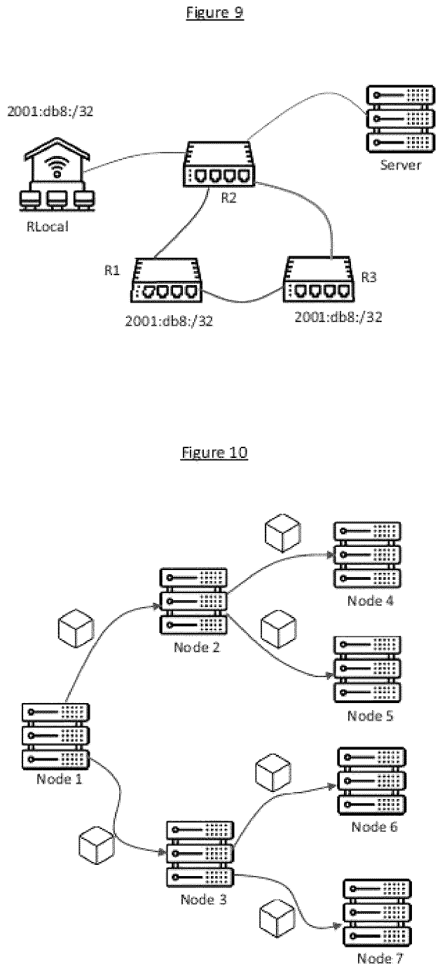

When the data packet is sent from the server it is routed through the Internet to the multicast address (e.g., ‘RLocal’ in FIG. 8, which shows a multicast transmission from a Server to subscribers PC1 and PC2). On the packet's arrival, the subscribers e.g. PC1 and PC2, are able to retrieve the data, whereas non-subscribers PC3 and PC4 will ignore the data packet. Thus, multicast reduces the need to send two separate data packets from the server to PC1 and PC2. Only on arrival at RLocal are separate copies of the data packet created.

For the multicast packet to have arrived at PC1, the resource PC1 would have to make a report to RLocal that they would like to join the multicast group FF00:/8. When RLocal sees this report, it will open an interface to PC1 with the promise of forwarding any multicasting messages to PC1 if it sees any of the multicast packets on the network. A router in the network (e.g., R2) would have been selected as the Rendezvous Point (RP) for the multicast to FF00:/8. Knowing that the best path to R2 runs through R1, RLocal will send a join report to R1 asking R1 to forward the request for the FF00:/8 multicast transactions to the Rendezvous Point R2. R1 will send a join report to R2. If the Rendezvous Point is to receive a multicast packet it will forward this packet to R1 which then passes it on to RLocal, which then in turn passes it on to PC1.

### Multicast Listener Discovery (MLD) and MLD Snooping

As known in the art, MLD is built into the IPv6 protocol. See, for example, en.wikipedia.org/wiki/Multicast Listener Discovery. MLD snooping uses MLD to provide numerous efficiencies because it avoids flooding packets across networks and thus transmission of data to network resources that have not signalled an interest in receiving that data. In addition, it provides improved network security because it avoids Denial of Service (DoS) attacks from unknown network sources.

By default, MLD snooping is disabled. As a result, when a switch receives a packet that has a multicast address it is sent to all interface ports in its VLAN except the port that the packet was received on. In other words, the switch floods the packet across the VLAN. If a resource is not a member of the multicast group and not interested in the data on that channel, it ignores the packet. Clearly, this gives rise to unnecessary network traffic and inefficient use of energy and processing resources.

However, when MLD snooping is enabled, the switch forwards the multicast-addressed packet only to interface ports that that have signalled an interest in receiving packets destined for that address. In other words, it only sends the packet to ports belonging to members that have subscribed to that multicast group. Thus, MLD snooping allows a sending resource to selectively transmit data packets to resources which have indicated an interest in receiving them. If no network resources are subscribed to the multicast group, the sending resource does not send any packets. Further details can be found at: techhub.hpe.com/eginfolib/networking/docs/switches/WB/15-18/5998-8170_wb)2920_ipv6_config_guide/content/v33585413.html.

### Anycast

IPv6 anycast comprises a situation in which multiple routers share a common IPv6 anycast address. An anycast address, as shown in Table 1 above, shares the same prefix as global unicast address. For example:
2001:db8::a111:b222:0:abcd
   can also be used as an anycast address.

If a data packet is sent by a sending resource to an anycast address it is forwarded to the nearest router/nodes of a subscribed set of resources. While geographical distance is a factor in determining the nearest resource, there are other influencing factors in the calculation such as: number of hops, efficiency, latency and cost. In the end, for anycast, only one resource is expected to receive the data packet and is often described as a one-to-nearest transmission.

With reference to FIG. 9, which shows an anycast transmission from a Server to Router R3, it can be seen that the packet is sent to the anycast address, 2001:db8:/32, shared by at least three routers (R1, R3, RLocal). The closest of these is R3 so the data packet is sent to R3. Recall that ‘nearest’ does not necessarily refer to geographical proximity.

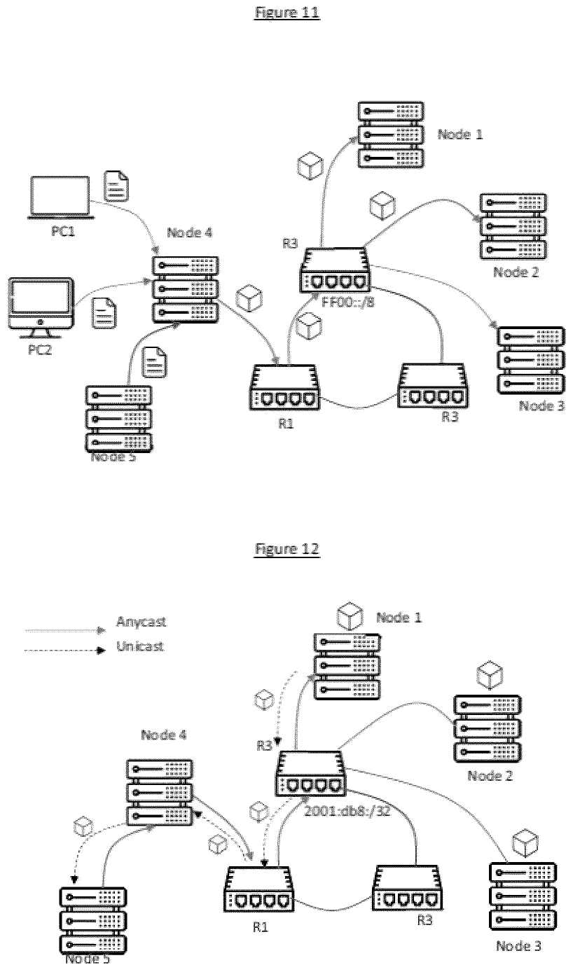

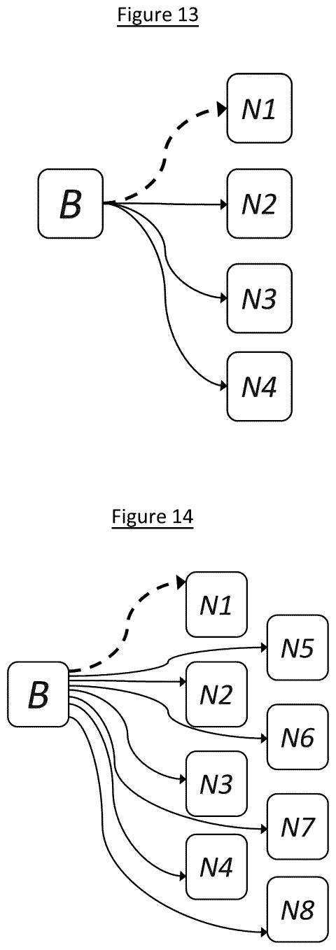

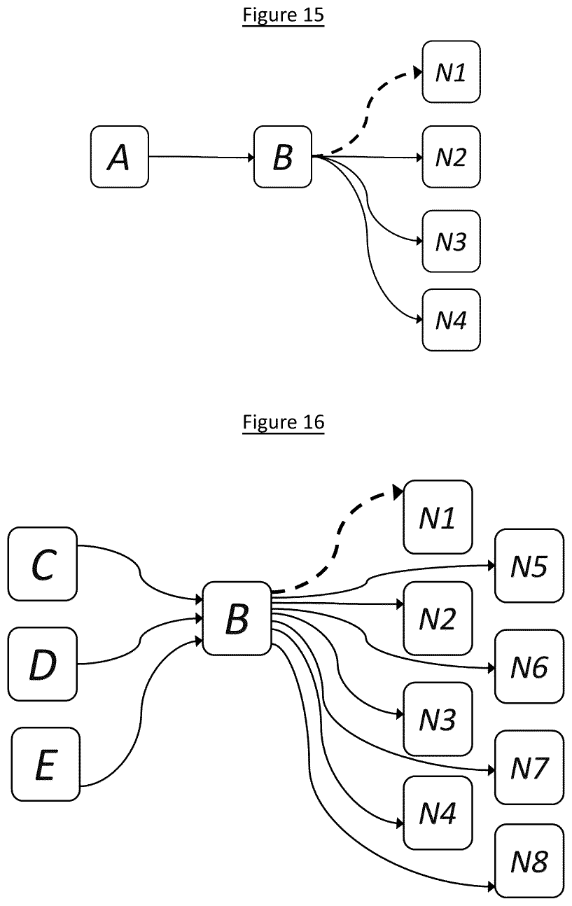

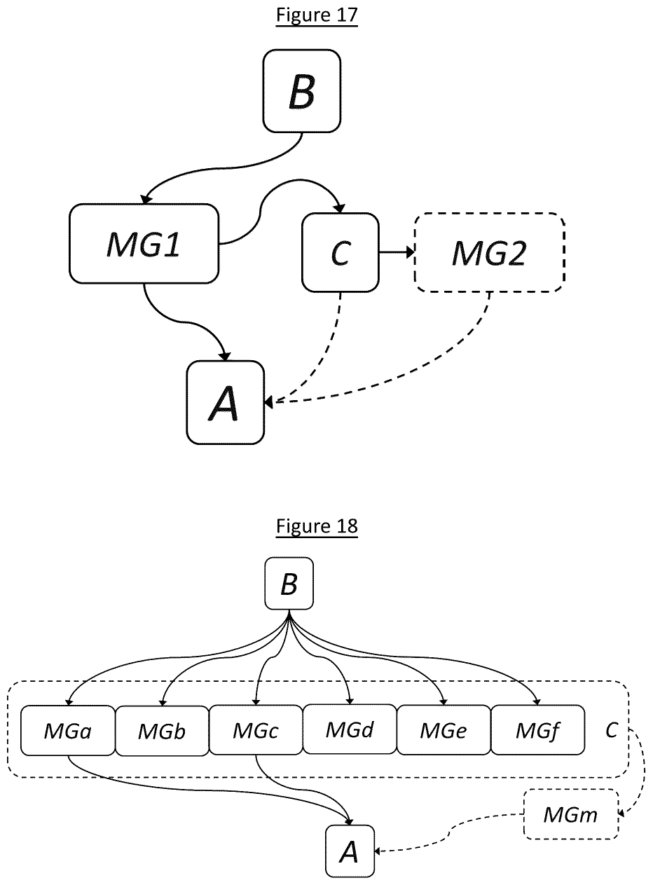

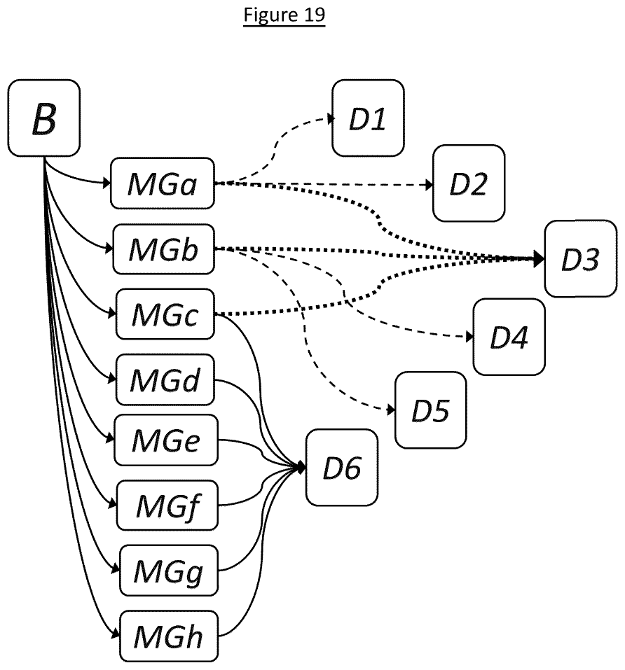

Anycast is particularly applicable for instances where speed of transmission is of particular concern. Network nodes (devices) may choose to join an anycast address by assigning themselves (i.e. a network interface) an anycast address. The anycast address is, essentially, a shared unicast address. The device can then send a transmission to the anycast address and the transmission will arrive at the topologically closest node (device) of the anycast address. This nearest device can then respond by taking any appropriate action based on the transmission it has received, e.g. forward the transmission to another destination, perform a calculation, process the received data in some way, send an alert to one or more receivers etc. FIG. 10 shows propagation of data across a network, while FIG. 11 shows an example embodiment of the disclosure in which a node in a network performs a multicast transmission of one or more portions of data.

FIG. 12 shows an example of an Anycast transmission from Node 5 to anycast address 2001:db8:/32. Nodes 1, 2, and 3 have obtained copies of a particular piece of data e.g. a message, a cryptographic key, an output of a calculation, location data for a military target, executable code for a software installation or upgrade, a block or transaction ID on a particular blockchain ledger etc., On receiving the transmission that contains the data, they each assign themselves to the anycast address 2001:db8:/32. It is a shared understanding that this anycast address means that this address represents that the recipient is in possession a copy of the portion of data. Node 5 sends a request for a copy of the data to the anycast address; the node (of nodes 1, 2, and 3) that is the topologically closest will be the node that receives the request.

In the case of FIG. 12, the closest is Node 1. Said node will then, if it chooses, send a copy of the data to Node 5 via unicast. Given the node that is in closest proximity is chosen, this means that Node 1 is likely to more quickly receive a complete copy of the data.

Note however that ‘nearest’ node is dependent on several factors other than geographical proximity; latency and costs were listed as factors in its determination. If the channel to Node 1 becomes overwhelmed with data transmissions and data-requests, the calculation of ‘nearest’ will possibly select another node as the new nearest node. This distributes the requests and data transmissions across the nodes in possession of new data. In some cases, the request for the data can be performed through the anycast request. When the nearest node is determined, a unicast transmission can be sent from the requesting node (Node 5) asking for the outstanding data from the nearest node (Node 1). The data will be sent to the requesting node (Node 5).

### Mobile IP and IPv6 Protocol

In some illustrative embodiments, the use of Mobile IP and the IPv6 protocol can provide enhanced flexibility in how services are accessed. Mobile IP and IPv6 are both networking protocols, but they serve different purposes and are used for different networking aspects. Mobile IP is a standard protocol that allows users to move from one network to another while maintaining their original IP address. This is particularly useful for mobile devices, such as smartphones or laptops, that need to switch between different networks (e.g., moving from a home Wi-Fi network to a cellular network) without disrupting ongoing activities or sessions. In a Mobile IP setup, a device generally has two IP addresses:
Home Address: The IP address assigned in the home network remains static.
Care-of Address: A temporary IP address assigned by the foreign network that the device is visiting.

A third component, the “Home Agent,” keeps track of the mappings between the two addresses and forwards packets accordingly.

In the context of the present disclosure, embodiments combine the benefits of Mobile IP and IPv6 to create a more flexible, secure, and scalable network architecture. With Mobile IP, users can seamlessly move between networks, while IPv6 ensures a vast, virtually limitless number of unique addresses and improved security features. As each device controller has its own set of associates devices, their block of IPv6 addresses can be used across multiple devices and services. Thus, the network is able to effectively “follow” users/devices from one location to another, e.g. from mobile phones to home networks, and even to various services such as telephony or internet-related services while maintaining high levels of security and privacy.

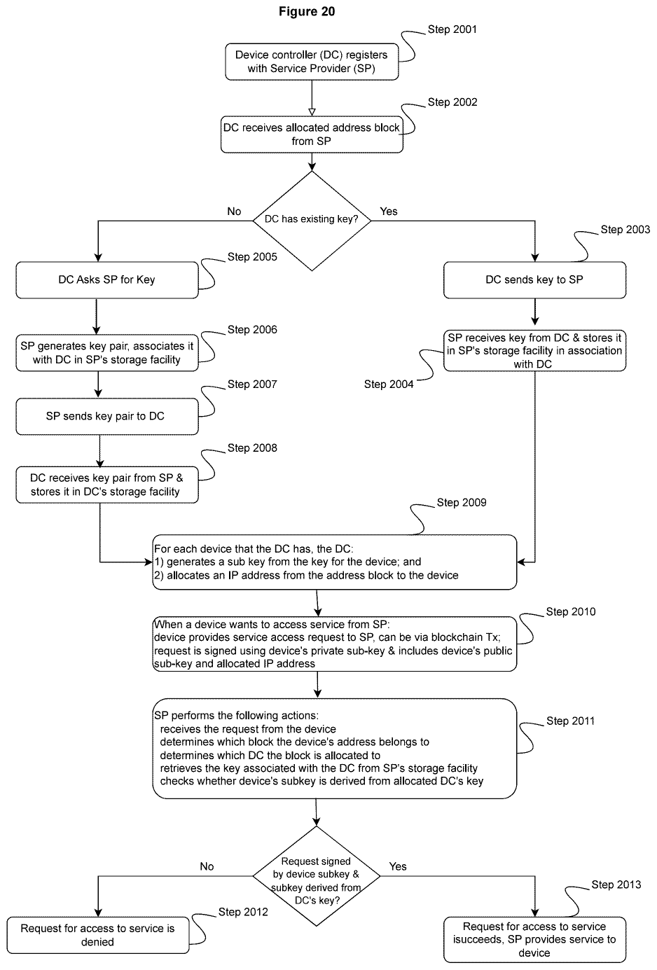

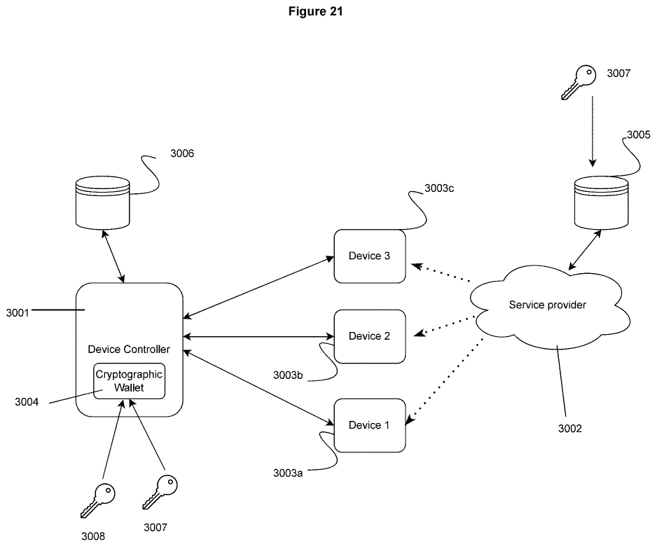

Turning now FIG. 13 onwards, and with particular reference to FIGS. 20 and 21, a solution is provided that utilises these transmission techniques for fast, secure and scalable distribution of data across a network, and improved control of multiple devices that need to receive data across the network. The plurality of devices 3003a, 3003b and 3003c is controlled, at least in part, by a device controller. Although 3 devices are shown in FIG. 21, this is clearly for illustration only and more or fewer devices may be associated with the device controller. Advantageously, embodiments of the disclosure allow for devices to be added or removed from association with the device controller. This may be achieved, in some examples, via a piece of software (app) provided by the device controller and installed on the device (3003a, 3003b or 3003c) to enable provisioning or removal of cryptographic keys by the device controller to grant/remove authorisation of the device in respect of receiving the service provider's services.

By way of non-limiting illustration, the device controller could be a household with multiple laptops, phones etc for family members, or a taxi company that owns a fleet of electronic vehicles, or a company that issues laptops/mobile phones to travelling employees, or a military command centre needing to track and communicate with multiple user-worn devices, vehicles, drones etc out in the field. In many situations, access to the service by the individual devices needs to kept private. Advantageously, embodiments of the present disclosure provide pseudonymous access to data provisioning.

Thus, embodiments of the present disclosure can be arranged and configured to provide solutions that enable secure, pseudonymous and faster delivery of data provisioning services to end users that are associated with a shared or common controlling entity. In a preferred embodiment, the services are provided, at least in part, via electronic transmission of data across a computer-implemented network or data communications channel of any suitable, known type including services provided from or via a cloud-based computing resource. In some (non-limiting) examples, the services may comprise telecoms services such as telephony and/or internet services, or media and other digital content delivery such as via a streaming facility, videoconferencing services etc. Where the service comprises telecommunications could include telecom services such as the ability to conduct phone calls, sending/receiving text messages, or using mobile data. Embodiments are not limited with regard to the type or purpose of the services being provided or the purpose/nature of the data being provided.

In essence, a service provider 3002 provides data to one or more IP addresses if a request for provision of that data is verified by the provider as authorised by the device controller. The service provider may be external and/or unconnected to the device controller. For example, the service provider may be a third party that the device controller simply uses by contractual agreement for the provision of one or more specified services. In other examples, the service provider could be internal to, or have an organisational relationship to the device controller. For example, the device controller and the service provider may be separate departments within the same organisation. There may be one or more device controllers within the same organisation.

With reference to FIG. 21, in a preferred embodiment, a cryptographic key and an IP block is allocated to or associated with a device controller 3001 by a service provider 3002. The IP block comprises a range of IP addresses as known in the art. These addresses are preferably IPv6 address of any known type as discussed above. The cryptographic key may be part of a public-private key-pair as known in the art. The service provider stores at least the device controller's associated public key in a storage facility 3005, along with the range of addresses that has been allocated to the device controller 3001. The device controller 3001 can then allocate one or more of the addresses in the allocated address block to individual devices 3003a, 3003b and 3003c that are associated, permanently or temporarily, with the device controller.

In some examples, the key pair may be generated by the services provider 3002 and distributed to the device controller. In some other embodiments, the cryptographic key pair can be generated by the device controller 3001 (or another entity acting on behalf of the device controller). The public key can then be provided to the service provider without revealing details of the user's identity or other user-related data that needs to be kept secret such as location, date of birth, gender etc. The private key can be retained and kept secret by the device controller. In any event, regardless of where the key pair is generated, the device controller 3001 may store the cryptographic key pair in a storage facility 3006 that it has access to.

The cryptographic key pair enables the device controller 3001 and the devices 3003a, 3003b and 3003c that it is associated with to access the services that are provided remotely from the provider 3002. The device controller's keys serve as a control and verification mechanism that facilitates authorised access to the provisioned services. Additionally, or alternatively, the device controller's keys may be used as an encryption/decryption mechanism of data such as communications that are shared between the device controller 3001, the devices 3003a, 3003b and 3003c and/or the service provider. Thus, the identity of the device controller 3001 and its devices 3003a, 3003b and 3003c may be kept private and secure. Only the public key associated with the device controller may be revealed to the service provider, thus ensuring secure but pseudonymous access to the relevant services.

In some embodiments, key distribution may comprise sending the key pair to the device controller from the service provider, or sending the public key and/or access request from the device controller or one or more of the controller's devices to the service provider, across an electronic network such as a LAN or WAN, or across a public network such as the internet, or a wireless network or via text message or via any other suitable communications means. In some cases, transition of the data (request, key(s) etc) may be performed between the service provider, device controller and/or individual device(s) via a blockchain network and/or (blockchain) ledger associated with a blockchain network.

In some cases, the key may be obtained by the device controller or service provider via a blockchain transaction. This may be performed using a digital wallet. The public key may be provided by the device controller in the transaction (e.g. in an output/script of the transaction) and the output containing the key may be spendable to an address controlled by the service provider. The transaction may be signed by the device controller using the private key. The service provider can use the public key to check the transaction's signature thus confirming that the device controller has the corresponding private key.

The advantage of providing the key via a blockchain transaction is that there is an auditable, immutable and timestamped record of the key that is associated with the device controller, and when the device controller has accessed it (by spending the output).

The key that is associated with the device controller may be referred to hereafter as its master key.

In a preferred embodiment, each device controller is associated with an IP block (otherwise known as an IP range). This is preferably an IPv6 block, comprising a range of contiguous IPv6 addresses. IP addresses within a device controller's designated IP block can then be linked to the user's various processing resources 3003a, 3003b and 3003c, such as mobile phones, laptops, IoT devices, vehicles and other devices that wish or need to access data supplied by the service provider. Thus, the device controller 3001 may be allocated at least one set of IP addresses. The service provider stores a record of the IP address that have been allocated to the device controller 3001 in its storage facility 3005. The service provider 3002 also stores a copy of the device controller's (public) cryptographic key. Thus, the service provider knows which master key(s) and which IP address range(s) are associated with a given device controller. Where multiple address blocks are assigned to a given device controller, different master keys may be associated with respective address blocks.

However, in other embodiments the same master key may be associated with more than one of the device controller's IP blocks.

Advantageously, each of the device controller's associated devices may serve as a mobile node. Therefore, each of the device controller's devices may be associated with a home address that is a member address of the user's assigned IP block. The device controller's respective devices 3003a, 3003b and 3003c may be arranged for non-permanent association with at least one care-of address that is associated with a network that the device temporarily connects to. Thus, embodiments of the disclosure may involve the use of, or combination or integration with mobile IP, mobile IPv6 or

### Hierarchical IPv6 (HMIPv6).

In some embodiments, a device controller's associated devices 3003a, 3003b and 3003c may be organised into a hierarchy, or may be related to each other via some logical and/or technical relationship. In such cases, it can be advantageous to generate cryptographic sub-keys which derive from the master key. The generation of the subkeys can be performed by the device controller's cryptographic wallet 3004 so as to reflect the hierarchical or other relationships between the device controller's various devices. The subkey can be shared with the device 3003a, 3003b or 3003c by the device controller. In some embodiments, the key technique disclosed in WO2017/145016 (International application number PCT/IB2017/050856) may be used for sub-key generation. This technique is explained in summary in the section below entitled “International Patent Application PCT/IB2017/050856 (Published as WO/2017/145016)” and in more detail in the PCT application as published.

Advantages of using the PCT/IB2017/050856 technique include:
the deterministic generation of subkeys; this enables a verifying party e.g. the service provider to prove that the subkey provided in the access request has been derived from the master key that is known to belong to the device controller. In order to verify the subkey, the verifier may use a message that is agreed upon in advance between the provider 3002 and the device controller 3001, or that Is provided in some way by the controller 3001 or the requesting device 3003a, 3003b or 3003c. In some embodiments, the message may be provided within the request, or may be sent separately from the request, or may be calculated by the service provider using a pre-determined operation and/or operand(s)
the ability to generate a common i.e. shared secret between the two parties independently of each other; this means that the shared secret does not need to be transmitted or communicated between the two parties, thus avoiding the potential for interception by unauthorised parties. The shared secret can then be used to generate a key pair independently at each party e.g. the device and the service provider. The key pair can then be used to encode, decode and verify the legitimacy of subsequent communications between the parties, including transmission of data sent from the provider to the device as part of the requested and authorised service
the ability to generate hierarchies of subkeys; this means that the device controller's master key can provide a root for a hierarchy of permission mechanisms that reflect the organisation's structure. It also means that access to the services can be enabled/disabled by the device controller or a party that is authorised by it for entire sections or sub portions of the organisation.

In accordance with a preferred embodiment, the device controller is allocated a key and an IP block. Each of the user's devices is then allocated an individual access addresses from the user's IP block. As the device controller has been allocated a cryptographic access key by the service provider, or has generated the key pair themselves, the device controller (or another party on their behalf) can generate subkeys from their master access key for each of their devices. So each of the device controller's devices is assigned its own subkey(s) derived from the master key, and also assigned at least one address from the device controller's allocated IP block. (We use the terms ‘assigned’ ‘associated with’ and ‘allocated’ interchangeably herein). The combination of the individual device's subkey and associated address(s) enables the individual devices to access the service in a pseudonymous fashion because only their subkey is revealed to the service provider. The service provider can prove that a given device's subkey has been generated from the device controller's master access key, so they can be sure that the device is authorised via the registered device controller. This provides the advantage that the individual devices can always be traced back to their authorising controller, and also that the verification and authorisation process for individual devices is simplified and improved. Each time the device controller acquires or receives a new device, they simply associate it with an IP address from the block and generate a subkey for it from their master key.

In some cases, the allocated address obtained by the service provider in association with the access request may comprise a “care of” address or a home address for the access requesting device (3003a, 3003b or 3003c) as known in respect of IPv6 mobile.

Each time a request is made to the service provider for access to a given service, the service provider can look up the requesting device's address in a storage facility such as a database, DHT, storage disk etc. Having determined the device's address, the service provider can then determine which block that address is in, and also which device controller is registered or associated with that given address block. The device controller's master access key, which is associated with the address block, can then be used to determine whether or not the device's cryptographic key has been generated from the registered master cryptographic key. If it has, then the service provider deems the device's access request to be authorised by the device controller.

In a particularly beneficial embodiment, after successful verification of the access request, data is communicated across a network e.g. the Internet, from one or more sending resources to one or a plurality of receiving resources. For convenience, we will call the one or more sending resources the ‘service provider’, and the receiving resources the ‘devices’ or ‘end devices’. In some scenarios, the receiving resources are organised in logical groups and each group can comprise one or more resources. The resources can comprise any type of computing resource and arranged for use for any suitable purpose. Each sending and/or receiving resource may comprise one or more hardware and/or software components, and may be arranged for communication with other resources over an electronic network. In some cases, a sending resource, receiving resource and/or device controller may comprise a digital (e.g. cryptographic) wallet for generation or storage of cryptographic keys.

FIGS. 18 and 19 illustrate how example embodiments can be used for controlled access to data provided by a service provider 3002. Advantageously, as the address allocated to a device (3003a, 3003b or 3003c) can be a multicast address, this means that the service provider only has to send the data or provide the service once, to one allocated address specified by an authorised requesting device, and that data can be distributed onwards throughout a potentially large number of end receivers.

Access to the multicast group can be controlled by any security mechanism such as the use of a password, cryptographic key etc. to prevent unauthorised access to the service. In one or more embodiments, access to the multicast group (and thus the data sent to subscribers of the group) may be controlled via the execution of a smart contract that is executed in association with a blockchain. This may be the Ethereum blockchain, the Bitcoin blockchain or a blockchain implemented via any other blockchain protocol. For example, users wishing to join the multicast group that is associated with the allocated address may be required to meet one or more conditions specified in the smart contract, and upon successful fulfilment of the condition(s) they may be provided with the necessary information to be able to subscribe to the group and begin receiving packets of data on from the multicast stream. For example, the user may be provided with a key or token or other resource that enables them to join the group. The conditions could comprise any suitable condition such as payment of a joining fee, or provision of identity-related data for verification of the user's identity etc. The same or a further smart contract may control ongoing access by the user to the multicast group and the data packets that are disseminated to/across it. For example, the smart contract may require that the user pays a fee, updates their identity verification documents or performs some other action at periodic intervals.

In our examples, the requesting devices that receive the provisioned data (3003a, 3003b or 3003c in FIG. 21) can be referred to as Alice ‘A’, Charlie ‘C’ or Dave ‘D’, and sending resources (service provider 3002 or an intermediary) can be referred to as Bob ‘B’ or Charlie ‘C’. Exchange of data may be accomplished using transmissions to one or more Multicast Groups ‘MG’, each group having its own, respective multicast address.

In FIG. 17, a sending resource represented by Bob B or Charlie C function to perform at least one of generating, storing, processing, accessing and/or maintaining a packet of data. The packet of data may include blockchain related data. Bob or Charlie send, at least in part, a transmission of the data from across an electronic network to a multicast group MG1, MG2. Bob represents a node controlled by the service provider 3002, from which the packets of data originate.

The multicast groups make the data available for an end-user. In some cases, this could be Alice A (shown as device 3003a, 3003b or 3003c in FIG. 21). In other cases, Alice may not be a subscriber to the multicast group that is associated with the multicast address that was allocated to her by the device controller. In such cases, Alice simply acts as the request and access control mechanism that interacts with the service provider (3002/Bob) on behalf of the device controller. In such cases, Alice is an intermediary between the service provider and the end users who subscribe to the multicast group but is not an end user of the service herself. In this way, Alice may play the intermediary role of Charlie, C.

Charlie, however, can also access and/or subscribe to multicast group MG1, and make said packet of data available directly to Alice, the end-user, or via a further multicast group MG2.

Hashed lines are used in FIG. 17 to indicate the optional transmission of the packet of data between Bob and Alice i.e. via Charlie. While Alice can obtain the packet of data from MG1, said data can be, for example, be a live transmission of multimedia data e.g. a football match. Alice may not be able to watch it live, thus an intermediary e.g. Charlie C also subscribes to receive the data from MG1 and store it to make it available to Alice independently of Bob's transmission. Charlie can transmit the data to Alice either directly or via a further multicast group, MG2, at a different time from the original transmission.

The data is transmitted directly to multicast group MG1 and indirectly to multicast group MG2, and authorised consumers/end-users of the data can obtain the data by subscribing to the multicast groups.

Referring now to FIGS. 20 and 21, an example of a possible data flow in accordance with an embodiment of the disclosure is provided.

In step 2001, the device controller 3001 registers with service provider 3002 because the device controller wishes to facilitate provisioning of the service provider's services to various devices 3003a, 3003b, 3003c that are associated with and/or known to the device controller. In some (but not all) cases, registration may comprise generation of a key pair by the device controller for association with the device controller. In some cases, registration may comprise capturing data relating to the device controller such as an IP address.

In step 2002, the service provider allocates a set of IP address for association with the device controller. Preferably, these are IPv6 addresses. The service provider may store a record of the allocation in a storage facility such as storage 3005. The service provider informs the device controller of the allocation. This may be achieved by transmitting information relating to the set of addresses across a network from the service provider to the device controller. Upon receipt of the information from the service provider, the device controller may store a copy of the information in a storage facility such as storage 3006. In other possible embodiments, the device controller or individual device 3003a, 3003b or 3003c informs the service provider of the address(s) that are already allocated to it. Either way, the device controller is now aware of the range of IP addresses that the service provider has allocated to the device controller.

In step 2003, the device controller may possess (in storage such as 3006 or cryptographic wallet 3004) or have access to an existing cryptographic key pair, or may generate a new key pair. The key pair comprises a private key 3008 and a public key 3007. In such a scenario as illustrated in FIG. 21, and where there is no relationship and/or trust between the parties, the device controller sends the public key 3007 to the service provider but keeps the private key 3008 secret. The service provider needs the public key 3007 to be able to verify the device's access request later in the process.

Upon receipt of the public key from the device controller, the service provider stores the public key in the device controller's account/in storage facility e.g. 3005 for future reference. It should be noted that when we say that a piece of data is stored in a storage facility such as 3005 or 3006, this is not limiting, and different portions of data may be stored in separate storage facilities.

In some cases, the device controller may ask the service provider for a cryptographic key pair (see Step 2005). The service provider then generates or otherwise obtains a key pair, associates it in storage with the device controller or the device controller's account, and sends the key pair to the device controller. Upon or after receipt from the service provider, the device controller stores the key pair in a storage facility e.g. 3006.

In other cases, step 2005 may be omitted and the service provider may send a key pair to the device controller automatically, i.e. without being asked to do. This may be done as part of, or upon/after conclusion of the registration process mentioned above at step 2001.

In yet other cases, for example where the service provider and the device controller have a relationship of trust, such as belonging to the same organisation, they may each generate the key pair independently using the technique disclosed in WO2017/145016 (International application number PCT/IB2017/050856) and an input that is predetermined, agreed, calculated or otherwise known to them both. In such cases, the key pair may actually be derived from another key, and/or the service provider and the device controller may store a copy of both the public and the private keys of the pair.

Upon conclusion of step 2008/2003, the device controller has a stored key pair and a set of allocated IP addresses. The service provider has at least the public key 3007 that corresponds to the private key 3008 of the device controller's key pair and has a stored record of which IP addresses it allocated (i.e. associated with) the device controller.

At step 2009, for each device that the device controller has control of, the device controller:
1) generates a key pair for each of the respective devices 3003a, 3003b or 3003c and sends the key pair to its device. In other cases, the device may generate the key pair itself or obtain it from another source rather than obtaining it from the device controller. In such cases, the device may inform the device controller of its private key. In a preferred embodiment, the key pair associated with a given device is generated deterministically and provably as a subkey of another key, which is derived ultimate from a master key known to the device controller;
2) and allocates at least one IP address to the device 3003a, 3003b or 3003c from the set of IP addresses allocated to it by the service provider.

In step 2010, when a device 3003a, 3003b or 3003c wants to access a service from the service provider, the device generates an access request and makes it available to the service provider. This can be achieved via any suitable mechanism as described above. Preferably, the request is signed by the device's private key. In some cases, it may also include the device's public key. It may also include the IP address(es) that the device controller has allocated to it. The address(es) that the request includes will be the receiver(s) of the service. In other words, upon successful verification, the service provider will send its data to the address(es) provided in the access request. In some cases, instead of providing the public key the access request may comprise an identifier that identifies the device controller or account so that the service provider can retrieve the public key from storage or obtain it via another means.

At step 2011, the service provider performs one or more of the following actions:
1) obtains the device's access request
2) determines the address block that the specified address belongs to
3) determines which device controller the block is allocated to
4) retrieves the public key associated with the device controller from the service provider's storage facility 3005,
5) if the device has provided a subkey, the service provider checks whether the device's subkey is derived from the device controller's key.

The service provider is able to use the device's public key to check the signature applied to the request or a portion thereof. If the service provider cannot verify that the signature has been applied by an authorised private key (e.g. it is a legitimate subkey derived from the device controller's key) the service provider will refuse to provide the requested service to the device (Step 2012). Alternatively, if verification succeeds at step 2013, the service provider sends the requested data to the address(es) specified in the request. The provisioning of the service is denoted in FIG. 22 via the dotted lines.

### In-Use Example: Streaming of Data

In light of the teaching and Figures herein, it is clear that the sending resource e.g. service provider's network node or router can transmit a plurality of packets of data, and/or the receiving resource e.g. end device can receive a plurality of packets of data. By way of non-limiting example, the packet of data can be multimedia data and, at least in part, a data stream, such as a multimedia communication channel provided by the service provider.

The multimedia data can be, for example, a football match, or sub-parts thereof. While a football match can be transmitted via a single channel that includes a combination of video and audio, the footage of the football match can be provided in many parts, with one or more parts being transmitted over different channels. For example, multiple video streams can be provided, each stream supported by a different channel. For example, parts can include different camera angles, goal-line camera views, audio-commentary in different languages, replays etc. Each of the channels can be transmitted in different packets of data to respective multicast groups.

Using FIG. 18 by way of example, suppose that node B is a service provider as discussed above. Node B is a sending resource that offers a streaming service that provides live sporting events to consumers. Suppose also that a particular hotelier owns hotels in London and Berlin, and wants devices in the hotel bedrooms and bars to be able to access the data that the service provider is making available. The hotel owner is the device controller, node B is the service provider. Suppose that the device controller has been allocated a range of IPv6 multicast addresses by the service provider, and the service provider has a stored (master) key that is associated with the device controller. The device controller then generates a subkey for its London hotel and another for the Berlin hotel.

The service provider (Node B in FIG. 18) can transmit packets of data in six different streams, to respective multicast groups, MGa to MGf, said packets including multimedia data for a live football match. Groups MGa and MGb receive packets of data including visual camera angle data, the former following the gameplay, and the latter showing exclusive goal-line activity. Groups MGc and MGd receive packets of data including commentary in different languages, the former in English, and the latter in German. Groups MGe and MGf receive packets of data for optional extras, the former providing exclusive replay actions, and the latter providing footage from a referee-mounted body-camera.

During the match, Alice (a television or other media-enabled device in a bedroom of the London hotel) wants to access the services from the service provider, so sends an access request to the service provider as described above. She may do this by writing a transaction to the blockchain that provides a signature and public-subkey to the service provider, and also at least one IP address that she has been given by the device controller. The service provider can use the IP address(es) to look up the device controller associated with that address. The service provider may perform checks such as “is the device controller's account in good standing?”, or “is this account still active?” etc. The service provider then a) checks that the subkey is derived from the stored key that the service provider knows has been allocated to or associated with the device controller; and b) uses the public sub-key provided in the request to verify the signature that Alice has provided.

Upon successful verification of Alice's subkey, the service provider makes the data available to Alice. Alice streams the match-play and English commentary by accessing multicast groups MGa and MGc. Simultaneously, and optionally, Charlie at node C (a television or other device in a bedroom of the Berlin hotel) performs the same request sequence as Alice, as described above. Upon successful verification, Charlie accesses and captures the data packets from all multicast groups MGa to MGf. The captured data is collected and/or aggregated by Charlie at node C and made available, separately and independently via a multicast group MGm, wherein MGm makes available all the data packets transmitted from node B to multicast groups MGa to MGf, thus offering all match information, languages and camera views on-demand. Devices that are authorised by the device controller to do so (i.e. they have been allocated at least one IP address and at least one sub-key) can access group MGm to watch match-play contained in the packet(s) of data again, or access additional information.

An intermediary, such as Charlie, can operate to consolidate e.g. pool packets of data from one of more multicast group for subsequent transmission to another multicast group that is authorised to subscribe to a multicast address that is allocated to the device controller.

Charlie could, for example, be a device in the Berlin hotel that registered guests can connect to via an app on their mobile phones or laptops. Upon check-in, the guest downloads the hotel's app onto their mobile device and the app generates at least one sub-key for the device and provides the relevant IP addresses from the device controller's allocated block. The mobile device's subkey pair will be derived from Charlie's subkey pair, and so a hierarchy of subkeys is generated. When the guest checks out of the hotel, the check-out system may notify Charlie who then sends an instruction to the app on the guest's mobile device to cause it to remove the subkey(s). Thus, the guest is only able to access the service provider's data while staying at the hotel. Other triggering conditions may be used for removal of the mobile device's subkey(s), such as a pre-determined time limit or period (e.g. the dates that the guest has paid to stay at the hotel) or that the device is probably within a geographical location e.g. the hotel.

The service provider i.e. node B can send a plurality of packets of data. Additionally, or alternatively, the packet of data can have sub-components providing a plurality of data channels. The packets of data can be separable for independent transmission to a multicast group according to (i) the function of the channel, as described in the example above in relation to different aspects of a football match, and/or (ii) be based on the packet of data itself.

Clearly, the teaching herein is not limited to a football match and, by way of other examples, the transmission of packets of data can be applied to: delivery drivers, wherein the service provider is a control room that sends out packets of data relating to delivery addresses, journeys to take, traffic information, weather information and the like such that it can be selectively received by delivery vehicles. In other examples, embodiments could be used for enhanced operation and/or coordination of drones that are controlled by a device controller and need to receive GPS or other location-related data, software updates, instructions or other data from a service provider. Yet other examples include situations where the device controller is a warehouse manager or production line operator that needs to control and direct multiple devices within a warehouse or factory and the service provider is a corporate department that provides instructions or operating data to the warehouse/factory for use by the devices; or subscription media services, such as Netflix™ or Sky™ television etc.

The packet(s) of data and/or the multicast group can be secured e.g. encrypted or otherwise locked by an access-key, wherein the access-key must be applied during a subscription to the multicast group and/or applied to the packet of data to control access to the content therein. Separate access-keys can be required to access different multicast groups and/or packets of data. For example, a first access-key can be required to access a packet of data, while a second access-key can be required to access the multicast group e.g. via a subscription. These can be sub-keys derived from the data controller's master key as explained above.

In some embodiments, the sending resource can determine whether an access-key is required to access a packet of data—by securing access to the multicast group and/or securing the data. The sending resource can manage the access to the multicast group e.g. manage the subscription, which requires an access key. In the examples, Bob B and Charlie Care sending resources, and each can respectively manage securing the packets of data they transmit and/or access to the multicast groups that they transmit to.

The device controller that manages a multicast group having an allocated multicast address can generate the access-key required by: the intermediary e.g. Charlie C, who acts as an aggregator, and pools packets of data for subsequent access by an end-user such as Alice; and/or the end-user e.g. Alice A, a subscriber. The access key, in one example, is provided to Charlie and Alice.

The access-key can be obtained by an intermediary or end-user e.g. aggregator or end-user in a conventional exchange i.e. providing an access-key in exchange for payment. In embodiments that use blockchain transactions to implement the access request, at least one access key can be provided to an intermediary or an end-user (i.e. device) via a payment channel, which are known from: wiki.bitcoinsv.io/index.php/Payment Channels.

Using a payment channel, at least one access-key can be exchanged for payment quickly and efficiently using blockchain transactions. In practice, an intermediary or an end-user can use and/or establish a payment channel to obtain a bundle of access-keys. The payment channel, and provision of keys can be handled by the service provider or the device controller.

Efficient access to secure packets of data using access-keys benefits from the use of a payment channel, wherein use of each key to subscribe and/or unlock a packet of data can trigger automatic payment to, for example, the sending resource, where the sending resource is the source of packets of data. An access-key can provide access to the multicast group and/or packet of data for at least one of (i) a fixed period of time, and (ii) a fixed quantity of data, (iii) a fixed quantity of units, (iv) a fixed number of packets of data, and (v) unlimited access.

The sending resource e.g. Bob or Charlie, can transmit packets of data to numerous multicast groups. The IPv6 protocol and scope of blockchain applications is such that the volume is packets of data being transmitted can be significant, said packets being transmitted to an equally significant volume of multicast groups. While this enables a scalable and granular means of disseminating packets of data, bottlenecks can be mitigated and the use of resources balanced.

In addition to the transmission and/or subscription and/or access techniques taught herein, sending resources can allocate packets of data to multicast addresses, wherein said multicast addresses are determined from at least one of: the packet of data; and the access key.

Allocation techniques taught in relation to features and embodiments of enumerated clause set 9 and elsewhere herein can be applied to complement the efficient and scalable solutions for transmitting data using IPv6, as taught herein. Balancing can inhibit bottlenecks in the transmission of packets of data, in particular when the packets of data are large blocks, which could result in a delay at a node or router, or when the packets of data are transactions and the volume of transactions floods the network by propagating in a universal manner.

FIG. 19 illustrates a further example of how a sending resource 3002 e.g. Bob, represented by node B, transmits packets of data to eight different multicast groups-nominally MGa to MGh. The packets of data can be transmitted to a respective multicast group based on the packet of data being transmitted,

Alternatively, the allocation can be determined using the access-key and/or the content of the packet of data. For example, the multicast groups—nominally MGa to MGh—can hold data associated with a geographical location, which is received from a transmission from node B, Bob, the sending resource. Each geographical location can have its own access key that can be obtained via a subscription.

In one example, the sending resource (3002 in FIG. 22, or B in FIG. 19) transmits packets of data e.g. map and traffic information associated with a city having eight districts. Six autonomous vehicles e.g. taxis, operating in a drone-like manner, are labelled D1 to D6 and are required to transport goods or occupants within the city. Each drone, D1 to D6, operating as a taxi determines its start and end-point for a given journey, and the districts it is required to travel through. The drone then accesses the corresponding packets of data associated with those districts from the multicast group associated with those districts e.g. by subscribing.

Each district and/or drone can be licensed. Therefore, for a drone to operate in one or more districts, it requires a license for each district, said license providing an access-key corresponding to the packets of data associated with the licensed district. Alternatively, or additionally, each drone can obtain a license and corresponding access key from the device controller 3001, or an entity authorised by the device controller, or by subscribing to the multicast groups from which the required license, map and traffic data can be obtained. A subscription can be made when required, and switched ‘on’ or ‘off’ according to requirements. The subscription to a multicast group to obtain packets of data for a licensed district can be time-based, unit-based etc.

In the example of FIG. 19, drones D1, D2, D4 and D5 start and stop in the same districts, and switch-on to receive, or otherwise subscribe to, respectively, multicast groups Mga and MGb. Drone D3, however, travels across three districts and accesses data associated with districts MGa, MGb and MGc. In contrast, drone D6 travels across six districts and accesses data associated with districts MGc to MGh. During normal operations, drone D6 may only operate in the district supported by MGc, and be required to travel to other districts on-demand. Drone D6, therefore, can take an annual subscription to the access-key for the multicast group MGc and/or the data it provides, while subscribing as-and-when required to other multicast groups when travelling in other districts.

Thus, the present disclosure provides methods and associated system requirements for a controlled transmission, dissemination and/or access to packets of data (as part of a provisioned service). The data can comprise information such as, for example, multimedia content, map data or similar content. Access can be achieved through subscriptions, which can be paid for using, for example, payment channels that are supported by blockchain nodes and a blockchain network. An example application can be a “pay per view” or “pay per use” service. Embodiments can be of particular use for applications in which enhanced control is required over data that is streamed from a source to multiple potential data consumers.

Thus, some examples provided herein relate to the transmission of data using nodes and/or routers, which optimise the dissemination and/or balancing of resources through management and/or allocation, as summarised in the clauses. In particular, examples relate to the controlled transmission and/or access to the data. More particularly, contractual access e.g. payment for the data is provided. In accordance with one possible aspect, the invention may reside in a computer-implemented method comprising operating a sending resource for generating, storing, processing, accessing and/or maintaining a packet or portion of data. The sending resource can be the originator of the packet(s) or portion(s) of data e.g. the creator or the producer, or a service provider, or the sending resource can be an operator, such as distributor who collates, aggregates or pools packets of data for subsequent transmission e.g. independently of the original transmission or creation of the data. The sending resource may send, at least in part, a transmission of the data from the sending resource (across an electronic network) to an allocated multicast address that can be accessed by (verified) devices associated with an authorised controlling entity. Devices can be added or removed dynamically by the device controller, without processing or cost implications for the service provider.

A plurality of packets/portions of data can be sent and/or received. By way of example, rather than transmit a movie in a large packet of data, said movie can be divided into multiple parts, each part being sent as a single packet of data. The packet of data can be, at least in part, a data stream, such as a multimedia communication channel. The packet of data can have sub-components for providing a plurality of data channels.

The end-user may typically be a consumer who accesses the packets of data via the multicast groups e.g. they are a subscriber. The multicast group and/or the packets of data can be secured, and a recipient e.g. an end-user can pay to obtain an access-key for accessing the multicast group and/or the packet of data. A plurality of access-keys can be provided. A first access-key can be required to access the packet of data. A second access-key can be required to access the multicast group.

The sending resource can generate the access-key. The sending resource can send the required access-key to at least one of the receiver and an end-user of the packet of data for accessing the packet of data. The access-key can be provided during an exchange using a payment channel. Additionally, or alternatively, in some embodiments a smart contract may be used in conjunction with a blockchain to control initial and/or ongoing access by the user to the multicast group. The smart contract may, when executed in association with the blockchain, require fulfilment of one or more conditions by the user in order to subscribe to the group and/or continue to be a member of the group.

The access-key can be configured to provide access to data and/or simultaneously represent a license and/or access to a digital asset or physical asset secured with a digital lock. The access-key can provide access e.g. to the multicast group and/or data, for at least one of (i) a fixed period of time, (ii) a fixed quantity of data, (iii) a fixed quantity of units, (iv) a fixed number of packets of data, and (v) unlimited access.

In another example, a computer-implemented method comprises operating a receiving resource for storing, processing, accessing and/or maintaining a packet of data, said packet of data preferably including blockchain related data. The method further includes receiving, at least in part, a transmission of a packet of data via a multicast group that received the packet of data from an electronic network, and consuming the data as an end-user. The data and/or access to the multicast group can be secured. The receiving resource can obtain access using an access key. The access key can be obtained via a payment channel.

The packet of data can include at least one of: a portion of a transaction (Tx); an output (e.g. UTXO) identifier; a hash of a script (e.g. a script associated with an output in a transaction); a transaction identifier (TXID); a blockchain block; and/or a block header.

### IN SUMMARY

By way of a non-limiting summary, the disclosure provides solutions for a comprehensive, secure and flexible framework for service provisioning across various platforms and services. Embodiments disclosed herein facilitate or enable a range of use cases across various industries and applications, at least in part due to its provision of secure, scalable, and flexible data service provisioning. Potential use cases include but are not limited to the following:
IoT (Internet of Things)
   Smart Homes: Device controllers in smart homes may securely allocate IP addresses to connected devices like thermostats, security cameras, and smart speakers
   Industrial IoT: In a factory setting, the method may securely manage data services for sensors, machines, and control units
Cloud Computing
   Resource Allocation: embodiments may facilitate in the secure, dynamic allocation of cloud computing resources among multiple clients
   Multi-Tenancy: embodiments may provide an additional layer of security and isolation between tenants in a multi-tenant cloud environment
Telecommunications
   Mobile Networks: embodiments may be beneficial for dynamically allocating IP addresses and data services to mobile devices in a secure manner
   Virtual Private Networks (VPNs): T embodiments may offer an additional layer of verification for business users needing secure remote access
Streaming Services
   Content Delivery Networks (CDNs): Securely manage the allocation of resources for optimised content delivery.
   Live Streaming: embodiments may securely and dynamically allocate resources during live streaming events.
Financial Services
   Secure Transactions: cryptographic elements/keys can be used for secure online financial transactions
   High-Frequency Trading: embodiments may assist in the provision of secure and speedy data services in trading environments where latency and security are paramount.
Blockchain and Decentralised Systems
   Smart Contracts: Execute and verify smart contracts securely.
   Tokenisation of Assets: Securely manage the data services related to asset tokenisation on a blockchain.
Health Services
   Telemedicine: Securely connect patients and healthcare providers in a telemedicine scenario.
   Patient Data Sharing: Secure, controlled sharing of medical records among healthcare providers.
Other
   Automated Vehicles: embodiments may be used for secure communication between automated vehicles and control stations.
   Military Applications: In scenarios requiring high security, such as military drone operations, the secure and dynamic allocation of resources may be vital.
In accordance with one possible interpretation, ‘provisioning’ may refer to allocating and managing resources within an organisation or a computational environment. Embodiments disclosed herein may provide computer-implemented methods that securely provide data services using allocated IP addresses and cryptographic keys. Some non-limiting examples of how such methods and systems can be used in various provisioning scenarios are now provided for illustration:
Cloud Resource Provisioning:
   Dynamic Allocation: The secure and efficient allocation of computing resources (CPU, memory, storage, etc.) may be optimised by the device controller, ensuring each client or service gets the resources it needs.
   On-Demand Scaling: With secure cryptographic keys, the on-demand scaling of resources without compromising security can be easily managed.
IoT Device Provisioning:
   Bulk Device Onboarding: For environments where numerous IoT devices need to be onboarded, the device controller can allocate IP addresses in bulk while maintaining high security through cryptographic keys.
   Device Identity and Trust: Devices can be allocated sub-keys generated from a primary cryptographic key, serving as identifiers and secure service access tokens.
Network Provisioning:
   VPN Allocation: The method may dynamically and securely allocate VPN addresses to employees in a corporate environment.
   Subnet Management: The controller may manage the allocation of subnets within an internal network, providing a layer of security through cryptographic keys.
Data Center Provisioning:
   Virtual Machine (VM) Allocation: Securely allocate VMs to different clients or departments within an organisation, ensuring that the VMs are both isolated and secure.
   Storage Provisioning: The cryptographic keys may serve as a security measure when dynamically allocating storage resources.
Database Provisioning:
   User Access: embodiments may can control who has access to specific databases and what kind of access they have (read, write, admin) based on cryptographic keys.
   Data Sharding: Data shards can be securely and efficiently allocated among different servers in distributed databases.
Telecommunications Service Provisioning:
   Dynamic Bandwidth Allocation: Service providers may use the disclosed embodiments to securely and dynamically allocate bandwidth to various clients or services.
   Mobile Data Plans: Some embodiments may be adapted to dynamically and securely manage various mobile data plans and services for many users.
Software License Provisioning:
   License Allocation: Software licenses may be securely and dynamically provisioned to users based on their needs and usage patterns, providing scalability and security.
Blockchain-Based Systems:
   Smart Contract Deployment: The secure provisioning of smart contracts on a blockchain may facilitate automated, secure transactions between parties.
The combination of IP address allocation and cryptographic security makes this method suitable for secure, dynamic, and flexible provisioning across many scenarios.
For Software Licensing:
In respect of software licensing, embodiments of the disclosed methods and systems may be leveraged to create a highly secure and flexible licensing framework. Embodiments may be applied to various aspects of software license provisioning, including at least:
Secure License Key Generation and Distribution:
   Cryptographic keys or key pairs could securely generate unique license keys for each customer or device
   Sub-keys generated from these cryptographic keys could be distributed to individual users or devices, allowing for more granular control and tracking.
Dynamic Allocation
   Embodiments of the disclosed methods and systems may support on-demand or dynamic allocation of software licenses, enabling businesses to provide licenses exactly when and where needed.
   The device controller could manage the allocation of licenses to specific IP addresses or computing resources, essentially locking the license to particular systems for added security.
Flexible License Types
   The same framework may be used to provision different licenses, from simple single-user licenses to more complex enterprise or network licenses.
   Additional services, such as data streaming or sharing, could be included as part of a licensed package and controlled via cryptographic keys.
License Verification and Compliance:
   Verification of the user at the service provider may be based on the cryptographic key or sub-key, ensuring that only authorised users can access the software or specific features within the software.
   This may assist in ensuring license compliance and the prevention of unauthorised distribution or usage.
Multi-Device Support:
   For users or organisations that require the software to be used across multiple devices, the device controller may allocate IP addresses to each device and manage them centrally.
   Each device/device user may have a sub-key, making it easier to manage multi-device licenses securely.
Blockchain-Enabled Transparency:
   By recording transactions on a blockchain, embodiments make is possible to maintain a transparent and immutable record of license allocations, renewals, and expirations.
   This may be particularly advantageous for compliance audits and resolving software usage disputes.
Enhanced Access Control:
Embodiments of the disclosed methods and systems may restrict software features based on the type of license purchased, all securely managed through cryptographic keys.
Real-Time Modifications:
Embodiments of the disclosed methods and systems may also support real-time license modifications, such as upgrades or downgrades, enabled securely through cryptographic sub-keys and digital wallets.
By integrating such features, embodiments of the disclosed methods and systems may offer a highly secure, flexible, and dynamic approach to software license provisioning. This may be advantageous in respect of the needs of both providers and consumers, ensuring compliance while offering the flexibility that modern software usage demands.
Music streaming services have fundamentally changed how users access and listen to music. Rather than downloading or purchasing individual songs or albums, users may use embodiments of the disclosure to pay a monthly fee to access a vast library of songs, albums, and playlists. The following non-limiting examples illustrate how music streaming may relate to technologies such as Mobile IP and IPv6.
Benefits of Music Streaming with Mobile IP:
1. Seamless Connectivity: Mobile IP makes it possible to switch from one network to another without interrupting music streaming. For example, a user's streaming may continue uninterrupted as the user moves from a home Wi-Fi network to a cellular network.
2. Location-Based Services: With Mobile IP, it is easier for services to offer location-specific content without disrupting the user experience.
3. Personalisation: the same Mobile IP address may be used (allocated) across multiple devices, allowing for a more personalised user experience as data about preferences and usage can be centralised.
Advantages of Using IPv6 Include:
1. Scalability: With the virtually limitless number of IP addresses provided by IPv6, each device (like your smartphone, laptop, smart speaker, etc.) may have its own IP address, making it easier for music streaming services to offer highly personalised experiences.
2. Improved Security: IPv6's enhanced security features can add a layer of security, making unauthorised access to accounts more difficult.
3. Quality of Service (QoS): IPv6 can support better QoS parameters than IPv4, which is essential for streaming high-quality music.
The combination of Mobile IP and IPv6 enables the provision of a versatile and secure user experience. A user may move from network to network seamlessly and from device to device without losing your session or logging in again. This can be particularly useful for those who use multiple devices to access their music library.
In accordance with disclosed embodiments, cryptographic keys may be used to allocate and/or authenticate access to streaming services, providing an additional layer of security and enabling new business models, such as more flexible subscription services based on usage. Integrating Mobile IP with IPv6 offers a seamless, secure, and highly personalised music streaming experience.

### NAP and Corporations

Mobile IP and IPv6 technologies could significantly improve how users authenticate to corporate servers and Network Access Protection (NAP) systems, enhancing both security and convenience.
1. Enhanced Security: IPv6's expansive addressing scheme make it more challenging for attackers to scan the entirety of an IP address space, thereby improving network security. Advanced cryptographic methods may be easily integrated for stronger authentication.
2. Seamless Roaming: Mobile IP allows seamless roaming across different networks without changing IP addresses. For corporate users who need to switch between various networks (e.g., from office Wi-Fi to a 4G/5G network), this ensures that they remain authenticated to the corporate servers without session interruptions.
3. Multi-Factor Authentication (MFA): Cryptographic keys or key pairs could be used with traditional authentication methods to add an extra layer of security. These keys may be stored securely in a digital wallet and verified rapidly on an IPv6 network.
4. Policy Enforcement: With Network Access Protection (NAP), companies may enforce policies for network access, ensuring that only devices meeting specific health criteria (like having up-to-date antivirus software) can access the network. IPv6 and Mobile IP can enhance this by making tracking and authenticating devices easier.
5. IoT and Beyond: With more and more devices connecting to corporate networks, IPv6 allows for better scalability. This may benefit not just computers and smartphones, but also IoT devices that require secure and authenticated access to corporate resources.
6. Improved Auditing and Monitoring: The combination of unique cryptographic (sub)keys and expansive IPv6 addressing allows for improved tracking of who accessed what, when, and from where. This is critical for corporate governance and compliance with GDPR, HIPAA, or SOX regulations.
7. Quality of Service (QoS): IPv6 also supports QoS features natively, allowing priority to be given to specific types of traffic, such as VOIP or video conferencing, which are crucial in a corporate setting.
8. Simpler Configuration: With IPv6, address auto-configuration becomes simpler, making it easier to manage large deployments of devices that need to connect to corporate servers.
Thus, the combination of Mobile IP and IPv6 can offer a more robust, secure, and efficient mechanism for authenticating corporate servers and complying with NAP policies, significantly improving user experience and security posture.

### Service Provisioning Using Blockchain Transactions

Examples described above show how the blockchain can be used for, amongst other things, the secure distribution of access requests for use in providing a service. Blockchain transactions may additionally or alternatively be used to provide the service itself. That is, data relating to the service provided by the service provider may be included in one or more blockchain transactions (in encrypted or plaintext form) that are sent to the blockchain. Each service may be associated with a particular one or more of the allocated IP addresses. The service provider includes the service-related data in one or more blockchain transactions that are sent to the associated IP address. The devices then uses the IP address that is has been allocated to obtain the one or more blockchain transactions, e.g. by listening to and/or subscribing to the IP address. In some examples, a device may also send data relating to the service as part of a blockchain transaction sent to the IP address associated with the service. A blockchain node or service provider may monitor the IP address for transactions. A node may then choose to record the transaction on the blockchain. A service provider may process the data contained within the transaction.

In some examples, the one or more IP addresses associated with a service may be generated based on that service. That is, the IP address is a function of some aspect of the service, such as the name and/or identifier of the service, the name and/or identifier of the service provider, etc. The IP address may also be based on an identifier of the device to which it is allocated and/or an identifier of the device controller. The IP address may be cryptographically linked to the service, e.g. the IP address may comprise or be generated based on a hash of some aspect of the service.

These examples provide an efficient mechanism for obtaining transactions having application (or service)-specific data without having to obtain or listen for all transactions, such as those not relating to the application of interest.

These examples allow for the optimising of traffic management on the blockchain to enable users to receive only the transactions they are interested in. This creates an overlay network with all the transactions required to run a specific application or service. An overlay network is established by partitioning network traffic using (e.g. IPv4 or IPv6) multicast addresses linked to uses-cases and/or applications. This way, users and other interested parties may listen just to the part of the traffic they are interested in. The traffic relative to an application may include transactions sent for publication from a user/application, transactions published by a blockchain node with a respective SPV proof, or any other information that could be of interest or relevance for that application, e.g. alerts, updates, etc.

Several advantages are provided by these examples. For instance, use-case specific overlay networks created by distributing transactions using IP addresses linked to the use-case reduces overall network traffic (i.e. number of transactions exchanged) as only the interested party receives them. In addition, application/service providers and users are provided with a simplified interface to the blockchain. They need only submit transactions to a multicast address linked to the application and, optionally, wait for an SPV proof, rather than connecting to a blockchain node.

Embodiments make use of multicast addresses for communicating application-specific data. An application may take any form, such as a protocol, e.g. a communication protocol such as instant messaging, or a token protocol such as a CBDC. Each application is associated with (i.e. assigned) a dedicated multicast address, e.g. an IPv4 or IPv6 multicast address. The multicast address associated with a particular application may be assigned by the application owner (e.g. a social media platform) or by a standards agency, such as IANA, the global coordination of the DNS Root, IP addressing, and other Internet protocol resources. In the latter case, the service provider may need to apply for address assignment. Users, devices, and other interested parties may subscribe to that multicast address to receive updates as described above.

The following use cases may be realised using the above-described examples:
A central bank may release a blockchain-based CBDC solution and monitor all the related transactions without the need to set-up a full node. Similarly, a user may send a direct payment (peer-to-peer) to another user. The payee broadcasts the transaction for publication in the blockchain, and both receive an SPV confirmation from the blockchain nodes 104.
A videogame may use the blockchain to record transactions. Players may subscribe to the multicast address to receive updates. In an even lighter approach, multicast addresses may be linked to different part of the game (e.g. different worlds, circuits, battles depending on the game).
A blockchain node 104 may specialise in validating transactions from multicast addresses. It processes them with high priority and responds quickly with SPV proofs. The blockchain node 104 may charge for premium services to applications and services that are willing to pay for priority or guaranteed SPV proofs.
A storage service may subscribe to a multicast address, store data and SPV proofs and sell access to data related to the specific application or use-case. Blockchain nodes 104 may prune the data, without impacting the functioning of applications and overlay networks.
A router service may help connect users to blockchain-based applications such as CBDCs.

### Government Service Provider

In some examples, the service provider may be a Government service provider that provides a service, by or on behalf of a Government or Government provider, or similar public body, e.g. an international organisation acting for or on behalf of one or more Governments. The service provider may be referred to as “GOvNet”, short for Government Overlay Network. This section describes the architecture for GovNet that may be implemented using embodiments of the present disclosure.

A feature of GovNet is the maintenance of a register with information relating to public administration and/or other governmental entities. This information can be produced by government authorities or citizens. Despite the name explicitly referring to government, this type of overlay network is equally suitable for any organisation that wishes to move their administrative infrastructure on a blockchain.

GOvNet is maintained by government servers (GSs) which communicate with the blockchain and approve the data that users submit to the GOvNet. GSs have the power to create transactions on a blockchain that provide proof-of-existence of the data. Users of the overlay network register to join. The registration relies on public key infrastructure and ensures only authorized and recognized users access the functionalities of the network. In the following, two main use cases for GOvNet are discussed: document management such as creation and distribution, and central bank digital currencies.

GOvNet is an overlay network maintained by a government that stores information relating to the government, its citizens, and other public or private entities This information can be produced by government authorities or citizens and can include citizen information (e.g., personal documents), governmental information (e.g., housing register), and payment services (e.g., Central Bank Digital Currencies).

GOvNet is maintained by network devices, called Government Servers (GSs). These servers process information within the overlay network, securely store data, and share it with other devices, such as users' devices, public offices, and other network devices. Government Servers guarantee data integrity and timestamping by publishing anonymised data to a blockchain. Only fingerprints of the data are published, to guarantee the privacy of authorities and users'.

Citizens willing to interact with GOvNet may be required to be identified and pre-authorised. Information lookup may be managed through an LDAP service.

Government Servers (GSs) are the main hardware infrastructure of a GOvNet. They can work as load balancers, replicating the required data, or have specific functionalities. In the latter case servers can be linked to specific use cases, for example one or more of them can offer registry office services, while others can support central bank digital currency (CBDC) transactions.

GSs process and store the information they receive from other GSs and authorised third parties. This information can be subsequently accessed by authorised parties for government-related services. Data are stored in internal databases, called GS Databases, maintained by the GSs.

Government Servers may offer one or more of the following functionalities:
GS Database: GSs store the information corresponding to the government services they offer in internal databases. Data can be stored in various forms (e.g., plaintext or hashed) to accommodate authorities and users' privacy.
Communication with other GSs: GSs communicate users' data and other information with each other to ensure that data is up to date and consistent.
Interaction with the blockchain network: GSs use blockchain technology to timestamp information and guarantee data immutability and authenticity. GSs manage all the services relative to transaction publishing and management, such as creating, funding, and publishing blockchain transactions containing the required data (or their fingerprints). A proof of publication (e.g., an SPV proof) is stored in the GS Database for lightweight verification.
Data validation: provide information on the status of data stored, when required for governmental usages (e.g., verify the validity of a driving license). This includes proof of publication on the blockchain (e.g., SPV proof) and a proof of inclusion in a GS Database. The proof of inclusion in a GS database is referred to as an overlay proof.
User Access Management: manage user services, such as verifying that users are authorized to create and access data. GSs communicate to interested users when the data has been added to the network and provide publication proofs (e.g., SPV proofs and overlay proofs).

GS Databases contain all the information required for a GS to offer its intended governmental services. For each piece of information received, the minimal information to be stored in these databases is:
Fingerprint of the information to be recorded (e.g., a document hash)
Proof of publication in the blockchain (e.g., SPV proof)—also referred to herein as a “blockchain proof”.
Proof of inclusion in GOvNet (e.g., overlay proof)—also referred to herein as a “storage proof”.

Optionally, documents and other pieces of data can be stored in the GS Database, either in plaintext or encrypted. If the document is stored, then GSs can offer data access services (e.g., retrieval of an identity card), otherwise they offer only proof of validity services (e.g., confirmation that a given identity card is legitimate, and not expired or revoked).

An SPV proof is a lightweight technique used to prove that a transaction is published on the blockchain. Usually, SPV proofs contain at least the Merkle proof of the transaction and the corresponding block header. The Merkle proof is used to prove that a given transaction is inserted in the block. The validity of the block is verified by checking that the block ID is part of the longest honest chain.

An overlay proof is a proof that some data has been accepted in GOvNet. Overlay proofs may be generated once the fingerprint of the data is added to a blockchain block. They may be unforgeable signatures associated to a public key derived from the data. Users can verify overlay proofs independently without relying on GSs.

The following use cases may be realised using GOvNet.

A government overlay network provides a natural framework to implement a CBDC protocol. CBDC transactions (i.e. blockchain transactions issuing and transferring CBDCs) may be submitted to the blockchain by GOvNet. GOvNet is agnostic to the design choices regarding the CBDC system.

Embodiments of the present disclosure may be used to store tax-related data. For instance, companies and/or individuals may use GOvNet to file tax returns, submit invoices, provide evidence of tax payments, etc. For individuals, GOvNet may perform checks to ensure that the tax-related data satisfies certain criteria. For example, a user submitting a tax return may be required to provide entries for different types of taxable income: salary, bonuses, dividends, investment returns, rent, etc.

Similarly, the overlay network may be used for recording licenses. For instance, a node of the network may specialise in recording television licenses, or business licenses (e.g. licenses to trade certain goods). A business may use a storage proof of their license to prove to regulators and the like that they have indeed been granted a license. Other types of licenses may be stored on the network, such as intellectual property licenses. The overlay servers may verify that a license for the same piece of IP has not already been granted (in the case of exclusive licenses, at least).

The overlay network may be used to store data related to ownership of land and/or vehicles and any change in said ownership. For instance, each data packet may contain a separate land or vehicle registration, or a transfer of ownership of a piece of land or vehicle. GOvNet may perform validation steps, e.g. to ensure that a piece of land is not being (inadvertently or fraudulently) sold twice. To do so GOvNet may verify that the same land is not already on the overlay network indicated as being owned by someone else. A user may use the proof of inclusion (storage proof) to verify that a seller of land or vehicle is the rightful owner of that land/vehicle.

GOvNet may also be used to prove something about a document (e.g. that a document exists, or that a document contains certain data or fulfils certain requirements) without revealing the document itself. Consider an age check for entry to a venue (such a pub, night club, etc.), one might what to prove they are over 18 without revealing their actual age or any other information which happens to be included on their ID document. In this context, one could give an overlay proof at the entrance to the venue, the security may use the proof to check with GOvNet that GOvNet has accepted the document and GOvNet may confirm that the user is over 18, without revealing any details. Since the security staff trust GOvNet, there is no need for any additional checks. Other similar uses cases include visas that permit the owner to enter a country.

Referring now to the embodiments described above, GOvNet provides services to users using the allocated IP addresses. That is, a service (e.g. document storage, CBDC issuance, age verification, ownership verification, document integrity checks, etc.) may be provided to a user (i.e. to their device) using the IP address allocated to that device.

For instance, the user may submit data (e.g. a document) to GOvNet from their allocated IP address. In response, GOvNet stores the data and/or a fingerprint (e.g. hash) thereof. GOvNet then submits to the user, using the allocated IP address, proof that the data has been stored at GOvNet's servers. The proof may be in the form of an overlap proof. Additionally or alternatively, GOvNet submits to the user, using the allocated IP address, proof that the data and/or the fingerprint thereof has been stored on the blockchain. The proof may be in the form of an SPV proof.

As another example, GOvNet may provide to the user, using the allocated IP address, service requests. E.g. GOvNet may send an indication to the user of whether a document is stored by GOvNet and/or whether a document satisfies one or more criteria. GOvNet may return information on data stored by GOvNet, such as who owns an asset (e.g. in the case of the land registry use case discussed above).

To summarise, some embodiments of the present disclosure provide a mechanism for proving that data has been accepted for storage on a storage network. The storage network may be maintained by a network of storage providers (e.g. nodes, servers, etc.). Data (or a hash or other type of commitment) is stored by the storage provider(s). Upon storing the data, the storage provider generates and provides a proof (e.g. a signature) of data storage which a user may use to verify, or prove to a different user, that their data has been stored. The proof (e.g. signature) proves that the data was accepted by the storage provider. A commitment (e.g. a hash) of the data is also stored on the blockchain. A proof of storage of the commitment on the blockchain may also be provided to the user.

### Terminology

As known in the prior art, the term “node” can mean a basic unit of a data structure (in Computer Science), or a point of connection in a communication network (networking/telecoms), an entity in a mesh network, or a computing resource that runs an implementation of a blockchain protocol e.g. a miner on the Bitcoin network. Alongside these, a device or system on a network can also be called a “host” or “peer”, depending on the context. In relation to the present disclosure there is, therefore, a potential for confusion between the various terms given that certain embodiments may encompass or intersect across various technical fields. Therefore, to avoid confusion and for the sake of clarity, we will use the umbrella term “network resource” “processing resource”, “computer-based resource” or simply “resource” to include “node”, “peer” or “host”, or any device/system on a network.

Also, we may refer herein to the Bitcoin protocol/network/ledger for the sake of convenience and because it is the most widely known of such technologies. However, the disclosure is not limited to use with Bitcoin and other ledger-based protocols/networks are intended to fall within the scope of the disclosure. For example, blockchain protocols, networks and implementations that comprise a Proof-of-Stake mechanism, or utilise an account-based model rather than UTXO-based, fall within the scope of the present disclosure. It should also be noted that “Bitcoin” is not limited to meaning any particular Bitcoin-related protocol, and any protocol or implementation flowing from, varying from or deviating from the original Bitcoin protocol is intended to fall within the scope of the disclosure. Public, private or permissioned blockchains also fall within the scope of the present disclosure.

The term ‘allocating’ as used herein is intended to include ‘communicating’ or ‘associating with’. Therefore, allocating a set of IP addresses to a device controller comprises associating the device controller with the set of addresses, and/or communicating the set of IP addresses to the device controller.

The terms ‘user’ includes an electronic, processor-based entity as well an individual or group of human beings.

### International Patent Application PCT/IB2017/050856 (Published as WO/2017/145016)

Embodiments disclosed herein may utilise one or more of the techniques disclosed in International patent application number PCT/IB2017/050856. PCT/IB2017/050856 discloses several embodiments and techniques that can be used to advantage in respect of the present disclosure. These include the generation of sub-keys from master keys, and the independent generation of common i.e. shared secrets by multiple parties.

In one aspect, PCT/IB2017/050856 relates to a technique for generating new cryptographic keys from existing keys. The disclosed technique enables an entity or party to take a cryptographic private-public key pair (which we call the master key) and apply a sequence of mathematical steps to derive a related key pair (that we call the sub keys) which stem from the master key pair. This allows the construction of chains and hierarchies of cryptographic keys which a verifier can subsequently prove, mathematically, are linked to each other.

By way of a high-level summary, the PCT/IB2017/050856 technique involves the use of a deterministic key (DK) for the generation the new cryptographic keys. This DK is based on a hash of a message. The nature or content of the message is not restricted or limited to any particular form. It could, in some examples, have some meaning or relevance to the parties involved or simply be an arbitrary or random value or string. The choice of the message will depend on the needs of the parties using the technique for a particular implementation or application. The message can, however, be safely transmitted between different parties even over an insecure communications channel such as the internet.

To illustrate the deterministic sub-key generation technique, suppose that Alice has a master public-private key pair that has been generated using Elliptic Curve Cryptography (ECC) and a common generator (G). The generator (G) may be selected by Alice according to some criteria, may be randomly generated or may be obtained by another party such as Bob. In some use case scenarios, G is shared with Bob over a communications network.

To generate Alice's private subkey (PvSK), she:
1. uses a hashing algorithm to hash a selected, obtained or randomly generated message (M). This produces a deterministic key DK:

$$DK = H ( M )$$

2. generates the PvSK using scalar addition (+) of her master private key (MPvk) and the DK:

$$PvSK = M P v K + D K$$

Note that:
in the above, the ‘+’ operator denotes scalar addition;
these steps produce a private subkey PvSK that is not a random value. Instead, it is deterministically derived from Alice's master private key MPvK.

Alice can then mathematically derive the corresponding public subkey (PubSK) using knowledge of her master public key (MPubK) and the message. To do this, she calculates:

$$PubSK = PvSK \times G$$

where the ‘x’ operator denotes elliptic curve point multiplication.

Note, though, that using the formula above for generation of the private subkey, this can be expressed as the following series of expressions:

$$\begin{matrix}1. & PubSK = ( MPvK + DK ) \times G \\ 2. & PubSK = MPvK \times G + DK \times G \\ 3. & PubSK = MPubK + DK \times G \\ 4. & PubSK = MPubK + H ( M ) \times G\end{matrix}$$

Therefore, another party e.g. Bob can also derive Alice's public subkey if he knows the relevant information i.e. the common generator (G), the message (M) and Alice's master public key. This is important because it enables various use cases.

For example, consider a scenario in which Alice and Bob wish to authenticate each others' identities and/or be able to communicate sensitive data between them in a secure manner. Suppose that Alice has a cryptographic key pair which we will call the master public/private keys and that she knows the same message as Bob. Alice can perform the mathematical steps set out above using her master private key and the message M (which she has hashed to produce the DK) to produce a new private subkey. Importantly, the corresponding public subkey can be mathematically derived using Alice's master public key and the message M. Therefore, if Bob knows Alice's master public key and M, he can generate her public subkey for himself without the need for it to be communicated over a communications channel and, therefore, risk being intercepted.

Now suppose that Bob performs the same steps set out above using his own public-private master key pair and the same message M. As a result, he generates his own pair of sub keys. Each party can then use their new private subkey to sign the message (or another piece of data) and send it to the other. They can then authenticate each other's identity because they can independently generate the other's public subkey and use that to verify that the signed communication must have been provided using the corresponding private subkey.

Another aspect of PCT/IB2017/050856 allows Alice and Bob to generate the same (common) secret independently of each other without the need to communicate the secret between them. This is detailed in pages 25 onwards of International publication No. WO/2017/145016. Alice and Bob can calculate the common secret for themselves by performing a mathematical operation using their own private subkey and the other party's public subkey—the latter of which they can calculate for themselves using the shared message M as explained above. This shared (i.e. “common”) and independently generated secret can be used for a variety of purposes, such as forming the basis of a secret key in a symmetric-key algorithm that can be used for secure communication between Alice and Bob without them having to communicate it over a network and risk it being intercepted by an unauthorised party during transmission.

Some important aspects that flow from the PCT/IB2017/050856 technique include (but are not limited to):
1) each sub key is deterministically & provably generated from a master key it is possible to prove, mathematically, that a given sub key originates from a given master; this is important, not least, for identity verification, traceability and provenance purposes; one way of expressing this is that there is a mathematical audit trail that can be followed from the subkey to its source
2) we can build levels and hierarchies of sub keys deriving from the master key this is important because we can build structures which reflect the relationships and organisational natures of entities e.g. companies;
   for example, a parent company can own a master key from which sub keys are derived for subsidiaries, and further sub keys for internal departments etc.
3) we can share secrets without having to communicate them to each other two or more parties can use the technique to generate the same mathematically generated and provable secret, and can do this independently of each other without having to send the secret from one to the other via a communications network

### Example System Overview

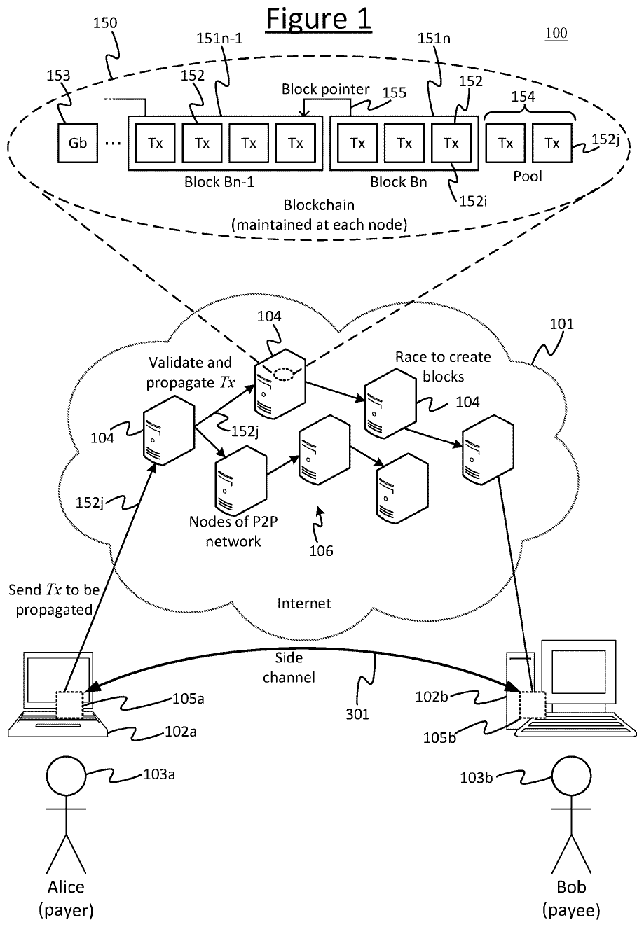

For the purpose of illustration only and with reference to FIGS. 1 to 4, we now provide an example of a computing environment in which one or more embodiments of the disclosure can be put into effect. The reference numerals referred to below refer to FIGS. 1 to 4.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

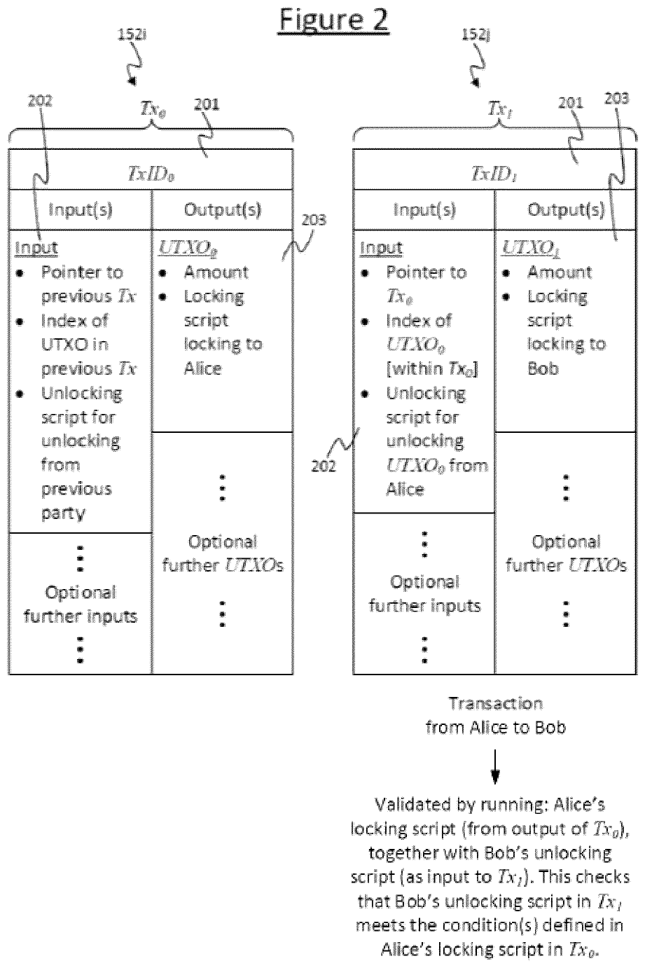

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$< Sig {P}_{A} > < {P}_{A} \text{>} ‖ [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

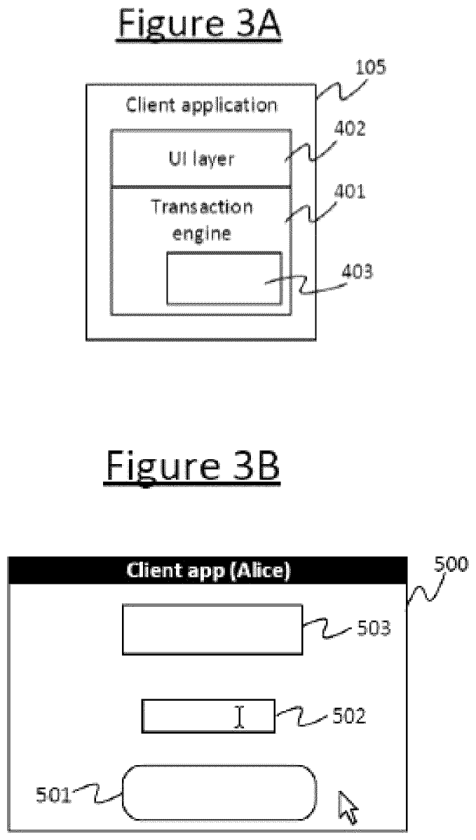

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example, the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### Node Software

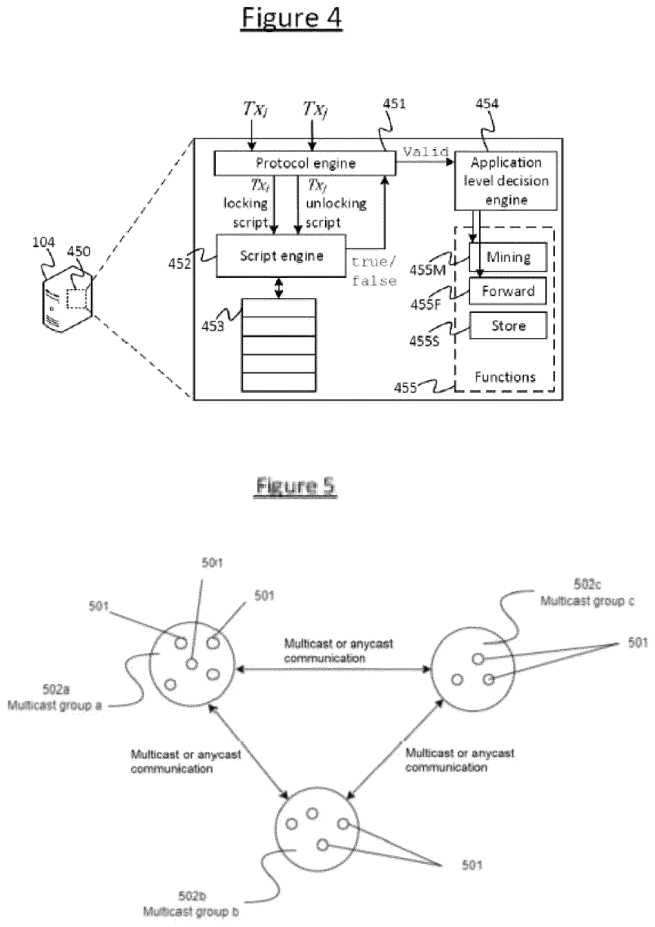

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Tx to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### ENUMERATED CLAUSES

Enumerated clauses are now provided for the purpose of illustrating some possible embodiments that may be provided in accordance with the disclosure. The clause sets provided below are for illustration and not to be construed as limiting, exclusive or exhaustive. Features recited in one clause set may be utilised and incorporated into one or more of the other clause sets. In any one or more of the following clause sets, embodiments may provide a computer implemented method, and/or a data distribution method. Additionally, or alternatively, embodiments may provide improved data transmission or exchange methods or improved electronic communications.

A computer implemented data distribution method is disclosed. The method may comprise sending a portion of (e.g. blockchain-related) data from a sending resource to one or more groups of receiving resources; each of the one or more groups may be associated with a respective address; the address may be a multicast address. Phrased another way, groups of resources may be formed wherein, for each group, resources are subscribing members of the group, and all members are associated with an address that identifies that group. Embodiments of the disclosure may comprise the step of generating, creating or providing an IPv6 multicast address.

One some or all of the receiving resources may be a full node 104 on a blockchain network, or a node in an overlay network that sits on top of but communicates with one or more full node(s) on the blockchain network. The sending resource may be a full blockchain node 104 or a node on an blockchain overlay network that sits on top of but communicates with one or more full node(s) on the blockchain network. These features may apply to one or more of the clause sets provided below.

Also disclosed herein is:
computer equipment comprising memory comprising one or more memory units and processing apparatus comprising one or more processing units, wherein the memory stores code arranged to run on the processing apparatus, the code being configured so as when on the processing apparatus to perform the method of any embodiment described or defined herein; and/or
a computer program embodied on computer-readable storage and configured so as, when run on one or more processors, to perform the method of any described or defined herein.

### Clause Set 1

Clause 1. A computer-implemented method of providing a data service from a service provider to at least one IP address from a set of IP addresses that is allocated, by the service provider, to a device controller associated with one or more computing resources; the method comprising:
   associating the device controller, by or on behalf of the service provider, with at least one cryptographic key or key pair; and
   allocating, by the device controller to at least one computing resource of the one or more computing resources, the at least one IP address from the set of IP addresses.
Clause 2. A method according to Clause 1, wherein the data service comprises one or more of:
   a cloud based service;
   a telecoms, telephony, internet or broadband related services, television or broadcasting services, or videoconferencing service;
   the provision of data;
   a data streaming or data sharing service.
Clause 3. A method according to Clauses 1 or 2, and further comprising:
   generating a sub-key from the at least one cryptographic key or key pair and assigning the sub-key to at least one computing resource of the one or more computing resources; and/or storing the at least one cryptographic key, key pair and/or subkey in a digital wallet.
Clause 4. A method according to Clause 3, wherein:
   the sub-key is generated deterministically and provably from the at least one cryptographic key.
Clause 5. A method according to any preceding Clause, wherein:
   the set of IP addresses is or comprises an IP block comprising a range of contiguous IP addresses.
Clause 6. A method according to any preceding Clause, wherein one or more of applies:
   the set of IP addresses comprises a range of IPv6 addresses; and/or
   providing of the data service from the service provider to the device controller comprises use of the IPv6 protocol, mobile IP, mobile IPv6 or Hierarchical IPv6.
Clause 7. A method according to any preceding Clause, wherein:
   the at least one cryptographic key and/or the sub-key provides an access control mechanism arranged for verification of the user at the service provider and, if verified, gain access to the service.
Clause 8. A method according to any preceding Clause, wherein at least one of the IP addresses in the set of IP addresses is a multicast address or an anycast address.
Clause 9. A method according to any preceding Clause, and comprising the step:
   providing the service from the service provider to the at least one of the IP addresses in the set of IP addresses that has been allocated or communicated to the at least one computing resource of the one or more computing resources.
Clause 10. A method according to any preceding Clause, and comprising the step:
   providing, from the at least one computing resource of the one or more computing resources to the service provider, an access request for access to the data service.
Clause 11. A method according to Clause 9, wherein the access request or the cryptographic key is provided via or using a blockchain.
Clause 12. A method according to any preceding Clause, wherein:
   the access request or a portion thereof, the at least one cryptographic key or key pair, or a subkey derived from he at least one cryptographic key or key pair is provided to or by the service provider via a cryptographically enforced electronic ledger; preferably wherein
      the electronic ledger is a blockchain leger implemented by a network of nodes on a blockchain network; and/or
      the access request or a portion thereof, the at least one cryptographic key or key pair, or a subkey derived from the at least one cryptographic key or key pair, is provided within an input or output of a blockchain script.
Clause 13. A method according to any preceding Clause, and comprising the step:
   allocating, by the device controller to the at least one computing resource of the one or more computing resources, a deterministic subkey derived from the at least one cryptographic key or key pair.
Clause 14. A method according to any preceding Clause, wherein one or more respective IP addresses of the set of IP addresses are associated with a respective application or service, and wherein the one or more respective IP address are generated based on the respective application or service.
Clause 15. A method according to Clause 15, wherein the one or more respective IP addresses are cryptographically linked to the respective application or service.
Clause 16. A method according to Clause 14 or Clause 15, wherein said providing of the data service comprises providing application- or service-related data in one or more respective blockchain transactions submitted to the respective IP address associated with the respective IP address.
Clause 17. A method according to Clause 16, comprising using the at least one IP address to send and/or receive the one or more respective blockchain transactions and/or one or more respective proof of inclusions associated with the respective one or more blockchain transactions.
Clause 18. A method of any preceding Clause, wherein said providing of the data service comprises:
   receiving a request to store data from a device allocated with a respective IP address;
   causing a commitment transaction to be submitted to a blockchain, where the commitment transaction comprises a commitment of the data;
   storing and/or publishing the data and/or the commitment of the data; and
   providing a storage proof to the respective IP address, the storage proof being generated in response to the commitment transaction being submitted to the one or more blockchain nodes and as a function of the data, the storage proof proving that the data and/or the commitment of the data has been accepted by the storage provider for storage.
Clause 19. A method of Clause 18, wherein the storage proof comprises a digital signature generated based on the data and/or the commitment of the data, and verifiable using a public key associated with and/or generated by the service provider.
Clause 20. A method of Clause 18 or Clause 19, wherein the commitment of the data comprises a hash of at least the data.
Clause 21. A method according to any of Clauses 18 to 20, comprising providing a blockchain proof to the respective IP address, the blockchain proof proving that the commitment transaction has been recorded on the blockchain.
Clause 22. A method of Clause 21, wherein the blockchain proof comprises a simplified payment verification (SPV) proof.
Clause 23. Computer equipment comprising: memory comprising one or more memory units; and
   processing apparatus comprising one or more processing units, wherein the memory stores code arranged to run on the processing apparatus, the code being configured so as when on the processing apparatus to perform the method of any preceding Clause.
Clause 24. A computer program embodied on computer-readable storage and configured so as, when run on one or more processors, to perform the method of any of Clauses 1 to 22.

### DISCLAIMER

No admission is made that any reference cited or referred to herein constitutes prior art. The discussion of any such references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in the UK, United State of America or in any other country.

International patent application number PCT/IB2017/050856 (published as WO2017/145016) and any derivative applications filed in the United States of America are incorporated herein by reference. All references cited herein are incorporated by reference to the maximum extent allowable by law, but any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A computer-implemented method of providing a data service from a service provider to at least one IP address from a set of IP addresses that is allocated, by the service provider, to a device controller associated with one or more computing resources;
the method comprising:
associating the device controller, by or on behalf of the service provider, with at least one cryptographic key or key pair; and
allocating, by the device controller to at least one computing resource of the one or more computing resources, the at least one IP address from the set of IP addresses.

2. The method of claim 1, wherein the data service comprises one or more of:
a cloud based service;
a telecoms, telephony, internet or broadband related services, television or broadcasting services, or videoconferencing service;
a provision of data;
a data streaming or data sharing service.

3. The method of claim 1, and further comprising:
generating a sub-key from the at least one cryptographic key or key pair and assigning the sub-key to at least one computing resource of the one or more computing resources;
and/or
storing the at least one cryptographic key, key pair and/or subkey in a digital wallet.

4. The method of claim 3, wherein:
the sub-key is generated deterministically and provably from the at least one cryptographic key.

5. The method of claim 1, wherein:
the set of IP addresses is or comprises an IP block comprising a range of contiguous IP addresses.

6. The method of claim 1, wherein one or more of applies:
the set of IP addresses comprises a range of IPv6 addresses; and/or
providing of the data service from the service provider to the device controller comprises use of the IPv6 protocol, mobile IP, mobile IPv6 or Hierarchical IPv6.

7. The method of claim 3, wherein:
the at least one cryptographic key and/or the sub-key provides an access control mechanism arranged for verification of a user at the service provider and, if verified, gain access to the service.

8. The method of claim 1, wherein at least one of the IP addresses in the set of IP addresses is a multicast address or an anycast address.

9. The method of claim 1, and comprising the step:
providing the service from the service provider to the at least one of the IP addresses in the set of IP addresses that has been allocated or communicated to the at least one computing resource of the one or more computing resources.

10. The method of claim 1, and comprising the step:
providing, from the at least one computing resource of the one or more computing resources to the service provider, an access request for access to the data service.

11. The method of claim 10, wherein the access request or the cryptographic key is provided via or using a blockchain.

12. The method of claim 10, wherein:
the access request or a portion thereof, the at least one cryptographic key or key pair, or a subkey derived from he at least one cryptographic key or key pair is provided to or by the service provider via a cryptographically enforced electronic ledger;
preferably wherein
the electronic ledger is a blockchain leger implemented by a network of nodes on a blockchain network; and/or
the access request or a portion thereof, the at least one cryptographic key or key pair, or a subkey derived from the at least one cryptographic key or key pair, is provided within an input or output of a blockchain script.

13. The method of claim 1, and comprising the step:
allocating, by the device controller to the at least one computing resource of the one or more computing resources, a deterministic subkey derived from the at least one cryptographic key or key pair.

14. (canceled)

15. The method of claim 1, wherein one or more respective IP addresses of the set of IP addresses are associated with a respective application or service; wherein the one or more respective IP address are generated based on the respective application or service; and wherein the one or more respective IP addresses are cryptographically linked to the respective application or service.

16. The method of claim 1, wherein one or more respective IP addresses of the set of IP addresses are associated with a respective application or service; wherein the one or more respective IP address are generated based on the respective application or service; and wherein said providing of the data service comprises providing application- or service-related data in one or more respective blockchain transactions submitted to the respective IP address associated with the respective IP address.

17. The method of claim 16, comprising using the at least one IP address to send and/or receive the one or more respective blockchain transactions and/or one or more respective proof of inclusions associated with the respective one or more blockchain transactions.

18. The method of claim 1, wherein said providing of the data service comprises:
receiving a request to store data from a device allocated with a respective IP address;
causing a commitment transaction to be submitted to a blockchain, where the commitment transaction comprises a commitment of the data;
storing and/or publishing the data and/or the commitment of the data; and
providing a storage proof to the respective IP address, the storage proof being generated in response to the commitment transaction being submitted to one or more blockchain nodes and as a function of the data, the storage proof proving that the data and/or the commitment of the data has been accepted by the storage provider for storage.

19. The method of claim 18, wherein the storage proof comprises a digital signature generated based on the data and/or the commitment of the data, and verifiable using a public key associated with and/or generated by the service provider.

20-22. (canceled)

23. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of providing a data service from a service provider to at least one IP address from a set of IP addresses that is allocated, by the service provider, to a device controller associated with one or more computing resources; the method comprising:
associating the device controller, by or on behalf of the service provider, with at least one cryptographic key or key pair; and
allocating, by the device controller to at least one computing resource of the one or more computing resources, the at least one IP address from the set of IP addresses.

24. A computer program embodied on non-transitory computer-readable storage medium and configured so as, when run on one or more processors, the one or more processors perform a method of providing a data service from a service provider to at least one IP address from a set of IP addresses that is allocated, by the service provider, to a device controller associated with one or more computing resources; the method comprising:
associating the device controller, by or on behalf of the service provider, with at least one cryptographic key or key pair; and
allocating, by the device controller to at least one computing resource of the one or more computing resources, the at least one IP address from the set of IP addresses.
